(19) United States
(12) Patent Application Publication
(10) Pub. No.: US 2017/0368454 A1
(43) Pub. Date: Dec. 28, 2017

(54) SYSTEMS, METHODS AND COMPUTER READABLE MEDIA FOR A VIEWER CONTROLLER

(71) Applicant: Proletariat, Inc., Boston, MA (US)

(72) Inventors: Seth John SIVAK, Cambridge, MA (US); Jesse David KURLANCHEEK, Cambridge, MA (US); Damon Brian IANNUZZELLI, Cambridge, MA (US); William Daniel OGLES, Cambridge, MA (US); Matthew Devon RILEY, Boston, MA (US); Luke PETRE, Randolph, MA (US); Joel Frederick MUKAI, Cambridge, MA (US)

(21) Appl. No.: 15/629,478

(22) Filed: Jun. 21, 2017

Related U.S. Application Data
(60) Provisional application No. 62/353,366, filed on Jun. 22, 2016.

(51) Int. Cl. A63F 13/335; A63F 13/87; A63F 13/86; A63F 13/822; A63F 13/803; G07F 17/32; A63F 13/35

(52) U.S. Cl. CPC A63F 13/335; G07F 17/3288; G07F 17/3244; A63F 13/87; A63F 13/35; A63F 13/822; A63F 13/803; A63F 13/86

(57) ABSTRACT

Systems, methods and media for controlling online video games are disclosed. For example, a controller system can receive first data associated with a game played at a player platform. Second data can be generated based on the first data, where the second data enables a viewer platform to provide a game participation feature(s) associated with the game. The second data can be transmitted from the controller system to the viewer platform. Third data based on the second data can be received at the controller system, where the third data is based on an interaction of a viewer with the game participation feature(s). Fourth data can be generated based on the third data, where the fourth data enables the player platform to alter the game based on the interaction of the viewer with the game participation feature(s). The fourth data can be transmitted from the controller system to the player platform.

### RELATED APPLICATION

This application claims benefit under 35 U.S.C. §119(e) to U.S. Provisional Patent Application No. 62/353,366, filed on Jun. 22, 2016, titled “Methods and Apparatus for a Viewer Controller,” which is explicitly incorporated by reference herein in its entirety.

### BACKGROUND OF THE INVENTION

### Technical Field

Embodiments of the present disclosure relate to systems, methods and computer readable media involving a viewer controller for controlling an online video game.

### Description of the Related Art

A video game can be played in various ways. For example, in a single-player mode, a person may play against the computer. In a multi-player mode, a person may play against another person over the network.

Game playing may be broadcasted over the Internet to viewers. For example, TWITCH™ Interactive, Inc. (San Francisco, Calif.), which is a subsidiary of AMAZON.COM™, Inc. (Seattle, Wash.), is one company that provides this service by streaming video games. Viewers watching a game broadcast can take only passive roles in the game. For example, they can cheer for a particular game player with other viewers. As another example, they can participate in offline events related to the game or game players. However, viewers cannot directly participate in the game or influence the game outcome. Thus, there is a need in the art to provide systems, methods, and media for making the player or viewer's experience more enjoyable by allowing the viewer to take an active role in the game.

### SUMMARY

In accordance with the disclosed subject matter, systems, methods and computer readable media are provided for controlling an online video game.

Before explaining example embodiments consistent with the present disclosure in detail, it is to be understood that the disclosure is not limited in its application to the details of constructions and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

A method of controlling an online video game according to one embodiment of the present disclosure can include receiving, at a controller system from a player platform, first data associated with a game played at the player platform; generating, at the controller system, second data based on the first data, wherein the second data enables a viewer platform to provide one or more game participation features associated with the game to a viewer; transmitting, from the controller system to the viewer platform, the second data; receiving, at the controller system from the viewer platform, third data based on the second data, wherein the third data is based on an interaction of the viewer with the one or more game participation features associated with the game; generating, at the controller system, fourth data based on the third data, wherein the fourth data enables the player platform to alter the game based on the interaction of the viewer with the one or more game participation features associated with the game; and transmitting, from the controller system to the player platform, the fourth data.

According to some embodiments, the second data can further enable the viewer platform to display the game in real time or substantially in real time.

According to some embodiments, the first data can be streaming data.

According to some embodiments, the streaming data can be received from a streaming data system that is connected to the player platform.

According to some embodiments, the one or more game participation features can include at least one of: a game altering feature, chatting, voting, sponsoring, placing a bet, playing a sub-game, or purchasing an item.

According to some embodiments, the game altering feature can include at least one of: changing a rule of the game, voting for a change to the game, or impacting a specific player of the game.

According to some embodiments, the game played at the player platform can be at least one of: a multiplayer online game, a simulation game, an adventure game, a strategy game, an action game, a first person shooter game, a sport game, a war game, a racing game, a role-playing game, or a puzzle game.

According to some embodiments, a type of the game can determine the one or more game participation features associated with the game.

According to some embodiments, the method can further include generating, at the controller system, fifth data based on the first data, wherein the fifth data enables a broadcaster platform to provide one or more broadcasting features associated with the game to a broadcaster; transmitting, from the controller system to the broadcaster platform, the fifth data; and receiving, at the controller system from the broadcaster platform, sixth data based on the fifth data, wherein the sixth data is based on an interaction of the broadcaster with the one or more broadcasting features associated with the game.

According to some embodiments, the method can further include receiving, at the controller system from a payment system, payment information associated with the viewer at the viewer platform.

A server for controlling an online video game according to one embodiment of the present disclosure can include a memory that stores a module; and a processor configured to run the module stored in the memory that is configured to cause the processor to: receive, from a player platform, first data associated with a game played at the player platform; generate second data based on the first data, wherein the second data enables a viewer platform to provide one or more game participation features associated with the game to a viewer; transmit, to the viewer platform, the second data; receive, from the viewer platform, third data based on the second data, wherein the third data is based on an interaction of the viewer with the one or more game participation features associated with the game; generate fourth data based on the third data, wherein the fourth data enables the player platform to alter the game based on the interaction of the viewer with the one or more game participation features associated with the game; and transmit, to the player platform, the fourth data.

According to some embodiments, the second data can further enable the viewer platform to display the game in real time or substantially in real time.

According to some embodiments, the first data can be streaming data.

According to some embodiments, the streaming data can be received from a streaming data system that is connected to the player platform.

According to some embodiments, the one or more game participation features can include at least one of: a game altering feature, chatting, voting, sponsoring, placing a bet, playing a sub-game, or purchasing an item.

According to some embodiments, the game altering feature can include at least one of: changing a rule of the game, voting for a change to the game, or impacting a specific player of the game.

According to some embodiments, the game played at the player platform can be at least one of: a multiplayer online game, a simulation game, an adventure game, a strategy game, an action game, a first person shooter game, a sport game, a war game, a racing game, a role-playing game, or a puzzle game.

According to some embodiments, a type of the game can determine the one or more game participation features associated with the game.

According to some embodiments, the module stored in the memory can be further configured to cause the processor to: generate fifth data based on the first data, wherein the fifth data enables a broadcaster platform to provide one or more broadcasting features associated with the game to a broadcaster; transmit, to the broadcaster platform, the fifth data; and receive, from the broadcaster platform, sixth data based on the fifth data, wherein the sixth data is based on an interaction of the broadcaster with the one or more broadcasting features associated with the game.

According to some embodiments, the module stored in the memory can be further configured to cause the processor to: receive, from a payment system, payment information associated with the viewer at the viewer platform.

A non-transitory computer readable medium according to one embodiment of the present disclosure can have executable instructions operable to cause a server for controlling an online video game to: receive, from a player platform, first data associated with a game played at the player platform; generate second data based on the first data, wherein the second data enables a viewer platform to provide one or more game participation features associated with the game to a viewer; transmit, to the viewer platform, the second data; receive, from the viewer platform, third data based on the second data, wherein the third data is based on an interaction of the viewer with the one or more game participation features associated with the game; generate fourth data based on the third data, wherein the fourth data enables the player platform to alter the game based on the interaction of the viewer with the one or more game participation features associated with the game; and transmit, to the player platform, the fourth data.

According to some embodiments, the second data can further enable the viewer platform to display the game in real time or substantially in real time.

According to some embodiments, the first data can be streaming data.

According to some embodiments, the streaming data can be received from a streaming data system that is connected to the player platform.

According to some embodiments, the one or more game participation features can include at least one of: a game altering feature, chatting, voting, sponsoring, placing a bet, playing a sub-game, or purchasing an item.

According to some embodiments, the game altering feature can include at least one of: changing a rule of the game, voting for a change to the game, or impacting a specific player of the game.

According to some embodiments, the game played at the player platform can be at least one of: a multiplayer online game, a simulation game, an adventure game, a strategy game, an action game, a first person shooter game, a sport game, a war game, a racing game, a role-playing game, or a puzzle game.

According to some embodiments, a type of the game can determine the one or more game participation features associated with the game.

According to some embodiments, the non-transitory computer readable medium can further have executable instructions operable to cause the server for controlling an online video game to: generate fifth data based on the first data, wherein the fifth data enables a broadcaster platform to provide one or more broadcasting features associated with the game to a broadcaster; transmit, to the broadcaster platform, the fifth data; and receive, from the broadcaster platform, sixth data based on the fifth data, wherein the sixth data is based on an interaction of the broadcaster with the one or more broadcasting features associated with the game.

According to some embodiments, the non-transitory computer readable medium can further have executable instructions operable to cause the server for controlling an online video game to: receive, from a payment system, payment information associated with the viewer at the viewer platform.

These and other capabilities of embodiments of the disclosed subject matter will be more fully understood after a review of the following figures, detailed description, and claims.

It is to be understood that both the foregoing general description and the following detailed description are explanatory only and are not restrictive of the claimed subject matter.

### BRIEF DESCRIPTION OF THE DRAWINGS

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

FIG. 1 is a block diagram illustrating a network of computer systems, including a viewer controller system, in accordance with some embodiments of the present disclosure.

FIG. 2 is a block diagram illustrating various components of a viewer controller system in accordance with some embodiments of the present disclosure.

FIG. 3 is an illustrative screenshot of a party interface for a broadcaster in accordance with some embodiments of the present disclosure.

FIG. 4 is an illustrative screenshot of a viewer interface in accordance with some embodiments of the present disclosure.

FIG. 5 is an illustrative screenshot of a viewer interface in accordance with some embodiments of the present disclosure.

FIG. 6 is an illustrative screenshot of a viewer interface in accordance with some embodiments of the present disclosure.

FIG. 7 is an illustrative screenshot of a channel currency store in accordance with some embodiments of the present disclosure.

FIG. 8 is an illustrative screenshot of a currency interface for a broadcaster in accordance with some embodiments of the present disclosure.

FIG. 9 is an illustrative screenshot of an In-App Purchase (IAP) store in accordance with some embodiments of the present disclosure.

FIG. 10 is an illustrative screenshot of a viewer interface in accordance with some embodiments of the present disclosure.

FIG. 11 is an illustrative screenshot of a viewer interface in accordance with some embodiments of the present disclosure.

FIG. 12 is an illustrative screenshot of a viewer interface on a mobile device in accordance with some embodiments of the present disclosure.

FIG. 13 is a block diagram illustrating a system that includes the viewer controller system in accordance with some embodiments of the present disclosure.

FIG. 14 is a flow chart illustrating a method for controlling a game in accordance with some embodiments of the present disclosure.

FIG. 15 is an illustrative screenshot of a party interface for a broadcaster in accordance with some embodiments of the present disclosure.

FIG. 16 is an illustrative screenshot of a viewer interface in accordance with some embodiments of the present disclosure.

FIG. 17 is an illustrative screenshot of a channel currency store in accordance with some embodiments of the present disclosure.

FIG. 18 is an illustrative screenshot of a currency interface for a broadcaster in accordance with some embodiments of the present disclosure.

FIG. 19 is an illustrative screenshot of an In-App Purchase (IAP) store in accordance with some embodiments of the present disclosure.

FIG. 20 is an illustrative screenshot of a viewer interface in accordance with some embodiments of the present disclosure.

FIG. 21 is an illustrative screenshot of a viewer interface in accordance with some embodiments of the present disclosure.

FIG. 22 is an illustrative screenshot of a viewer interface on a mobile device in accordance with some embodiments of the present disclosure.

### DETAILED DESCRIPTION

In the following description, numerous specific details are set forth regarding the systems, methods and media of the disclosed subject matter and the environment in which such systems, methods and media may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems, methods and media that are within the scope of the disclosed subject matter.

According to aspects of the present disclosure, systems, methods and media for a viewer controller allow integration with a streaming data system and provide platforms where broadcasters and viewers can participate. For example, a viewer controller system can integrate with a live video game streaming system. The viewer controller system can provide platforms for game broadcasters to make live commentary on the game and/or create parties for the game. The viewer controller system can further provide platforms for viewers to chat with each other, place bets on the game, and/or interact with the game and players by voting for changes to the rules of the game. Embodiments of the present disclosure related to the functionality and capability of the viewer controller system are further described below.

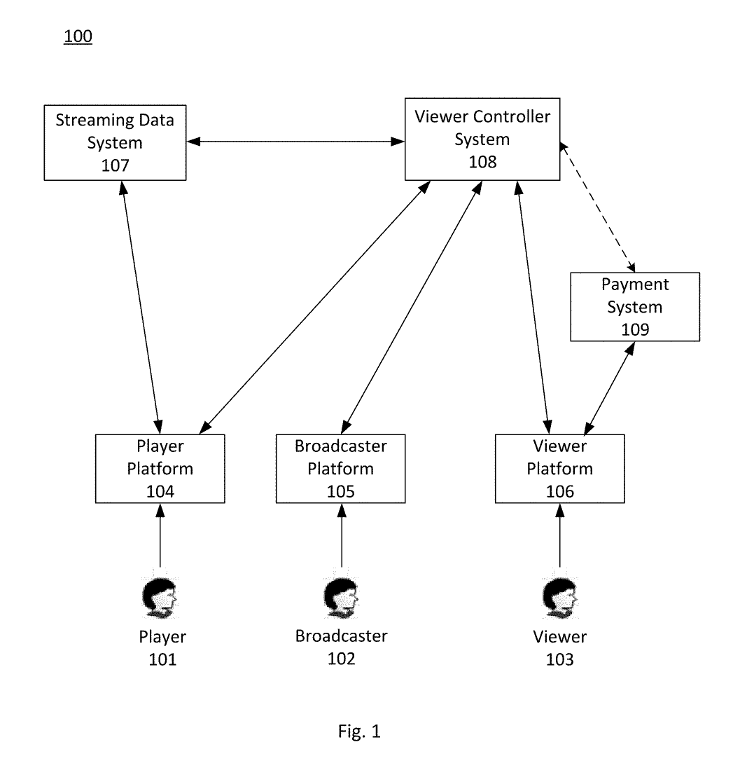

FIG. 1 is a block diagram 100 illustrating a network of computer systems, including a viewer controller system 108, in accordance with some embodiments of the present disclosure. In some embodiments, there can be one or more of different types of users. For example, there can be three types of users: a player 101, a broadcaster 102, and a viewer 103. The player 101 can be a person or a non-person entity, including a non-player character. In some embodiments, the player 101 can play a game by using a player platform 104. The game can be an online game and/or an offline game. The player 101 can interact with the player platform 104, which can include a device, such as a mobile device, a tablet, a personal computer, a gaming console, a TV, and/or any other suitable device. In some embodiments, the game can be implemented as software and/or hardware at the player platform 104. For example, the game can be a software application installed and executed on a personal computer.

According to some embodiments, the game can be a single-player game and/or a multi-player game. In the case of a multi-player game, there can be more than one player 101. In some embodiments, a plurality of players can play the game using the same player platform 104. For example, two players can use two separate controllers to connect to the same gaming console at the same player platform 104. Alternatively, some or all of the plurality of players can each use separate player platforms 104. For example, in a situation where five players are involved in a multi-player game, two of the five players can play the game using the same gaming console at the same house, while the remaining three players can each be in a different country and play the game each using an IPHONE™, a WINDOWS™-based computer, and a LINUX™-based computer. Four of the five players can be human players, while the remaining one player can be a non-player character played by a computer.

In some embodiments, the player platform 104 can include an interface to connect to a streaming data system 107. In some embodiments, the player platform 104 can be connected to the streaming data system 107 via the Internet, an intranet, and/or another type of network. In some embodiments, the streaming data system 107 can constantly receive streaming data from the player platform 104 and make the streaming data available to users and other systems.

According to some embodiments, the player platform 104 may need to be authenticated by the streaming data system 107 to access a certain restricted feature(s) of the streaming data system 107. Examples of these restricted features can include access to upload data, such as streaming data, from the player platform 104 to the streaming data system 107, and access to download information about a user(s) of the streaming data system 107 from the streaming data system 107 to the player platform 104. In some embodiments, the player platform 104 can be authenticated by the player 101 logging into the streaming data system 107 via an interface at the player platform 104. For example, using a personal computer, which is a part of the player platform 104, the player 101 can open a web browser to navigate to the login page of the streaming data system 107 website. In this example, the player 101 can enter the login credentials, such as the login ID and password of the player 101, on the login page. Once the streaming data system 107 verifies the login credentials and logs in the player 101, the player platform 104 can be considered to have been authenticated to access the certain restricted feature(s) of the streaming data system 107. In some embodiments, the connection between the player platform 104 and the streaming data system 107 can be partially or completely secure using a suitable technology such as, for example, the Secure Sockets Layer (SSL) standard.

According to some embodiments, the player platform 104 can include one or more devices. For example, the player platform 104 can include one or more of the following devices: a gaming console, a Light-Emitting Diode (LED) TV, a controller, a microphone, a keyboard, and/or any other suitable device(s). In some embodiments, the player 101 can play a game using the gaming console, the controller, and the TV, while speaking to the microphone and/or typing messages using the keyboard. Some or all of the data generated from these activities by the player 101 can be uploaded as streaming data to the streaming data system 107.

By using the streaming data system 107, the users can view the game played by the player 101. In some embodiments, the users can view the game in real time or substantially in real time. In other embodiments, there can be a delay between when the game is played by the player 101 and when the streaming data system 107 receives the data. There can also be a delay between when the streaming data system 107 receives the data and when the streaming data system 107 makes the streaming data available to the users and other systems. There can also be another delay between when the streaming data system 107 makes the streaming data available to the users and other systems, and when the streaming data is received by the users and other systems. An example of the streaming data system 107 is a system associated with the TWITCH™ platform, which is shown at www.twitch.tv. TWITCH™ provides a live streaming video platform, which hosts a number of channels, and broadcasts games played by players to users.

According to some embodiments, the player platform 104 can include an interface to connect to a viewer controller system 108. The player platform 104 can be connected to the viewer controller system 108 via the internet, an intranet, and/or another type of network. In some embodiments, the viewer controller system 108 can constantly receive streaming data from the player platform 104 and make the streaming data available to users and/or other systems. In some embodiments, the viewer controller system 108 can send data to the player platform 104 to alter the state of the player platform 104. For example, if a viewer(s) using the viewer controller system 108 votes on or purchases game rules to change the game, the game displayed to the player 101 via the player platform 104 can change. An example of a change to the game can include adding an obstacle(s) to the game such that one or more players at 101 can face a challenge(s) in the game.

According to some embodiments, the player platform 104 may need to be authenticated by the viewer controller system 108 to access a certain restricted feature(s) of the viewer controller system 108. Examples of these restricted features can include access to upload data, such as streaming data, from the player platform 104 to the viewer controller system 108, and access to download information about a user(s) of the viewer controller system 108 from the viewer controller system 108 to the player platform 104. In some embodiments, the player platform 104 can be authenticated by the player 101 logging into the viewer controller system 108 via an interface at the player platform 104. For example, using a personal computer, which is a part of the player platform 104, the player 101 can open a web browser to navigate to the login page of the viewer controller system 108 website. In this example, the player 101 can enter the login credentials, such as the login ID and password of the player 101, on the login page. Once the viewer controller system 108 verifies the login credentials and logs in the player 101, the player platform 104 can be considered to have been authenticated to access the certain restricted feature(s) of the viewer controller system 108. In some embodiments, the connection between the player platform 104 and the viewer controller system 108 can be partially or completely secure using a suitable technology such as, for example, the Secure Sockets Layer (SSL) standard. In some embodiments, single sign-on (SSO) can be implemented between the streaming data system 107 and the viewer controller system 108 such that the player 101 can log in to only one system and access the other system without separately logging in.

According to some embodiments, the viewer controller system 108 can be connected to the streaming data system 107 via the internet, an intranet, and/or another type of network. In some embodiments, the streaming data system 107 and the viewer controller system 108 can reside on the same physical system and thus, only a local connection may be necessary.

According to some embodiments, the viewer controller system 108 can receive the streaming data from the streaming data system 107 and/or the player platform 104. The viewer controller system 108 can make the streaming data available to users of the viewer controller system 108. In some embodiments, the streaming data from the streaming data system 107 can include video data related to the player 101 playing the game. In some embodiments, the streaming data from the player platform 104 can include data related to game stats, such as the players' scores on the leaderboard. The streaming data from the player platform 104 can be used by the game stat component 206, which is described below.

According to some embodiments, the users of the viewer controller system 108 can include the broadcaster 102 and/or the viewer 103. The viewer controller system 108 can make the streaming data available in various forms. For example, the viewer controller system 108 can make the streaming data available in a raw form. As another example, the viewer controller 108 can make the streaming data available in an altered form. In some embodiments, the streaming data is made available in a raw form if the viewer controller system 108 does not alter any content portion of the streaming data and provides such unaltered portion to the users of the viewer controller system 108. In some embodiments, the viewer controller system 108 can make the streaming data available in an altered form if the viewer controller system 108 alters any content portion of the streaming data. For example, the viewer controller system 108 can modify the brightness and/or contrast levels of the video, provided by the streaming data. As another example, the viewer controller system 108 can add a logo to the video, provided by the streaming data.

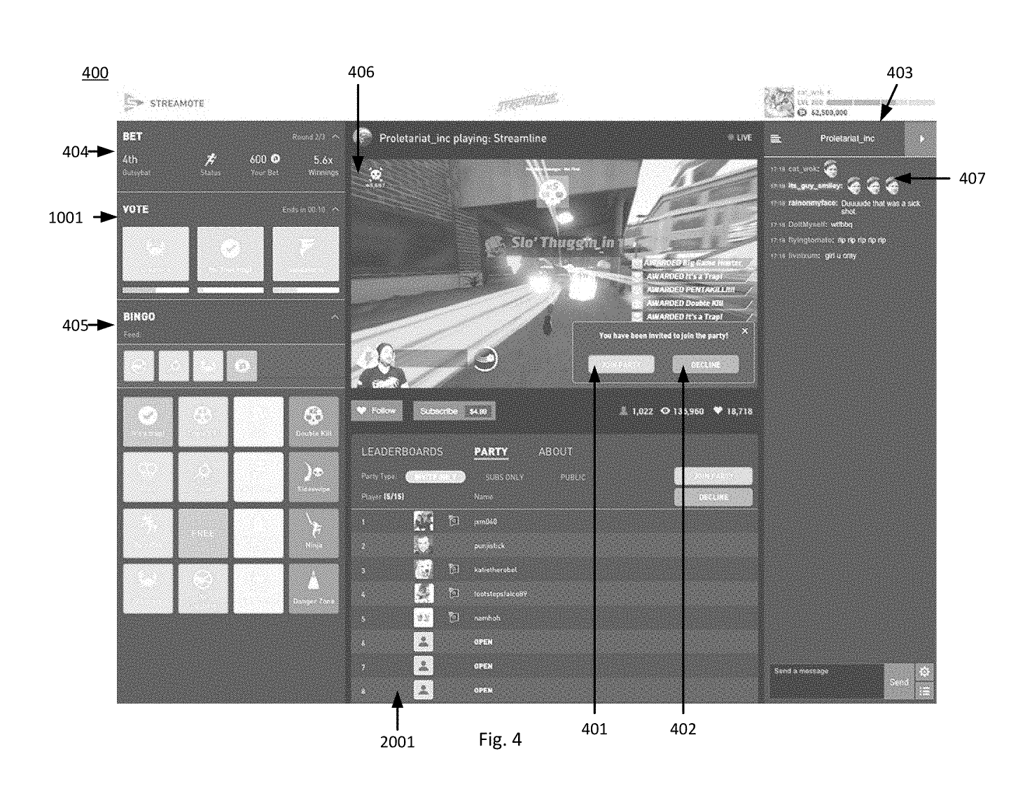

According to some embodiments, the viewer controller system 108 can make the raw and/or altered streaming data available to its users by incorporating the streaming data in a user interface that can provide other services. A viewer interface 400 in FIG. 4 is an example, where the streaming data, such as the streaming data from TWITCH™, is presented in a streaming data section 406 with other services, such as a bet section 404. FIG. 4 is described more in detail below. In some embodiments, the interface provided to the broadcaster 102 can be different from the interface provided to the viewer 103.

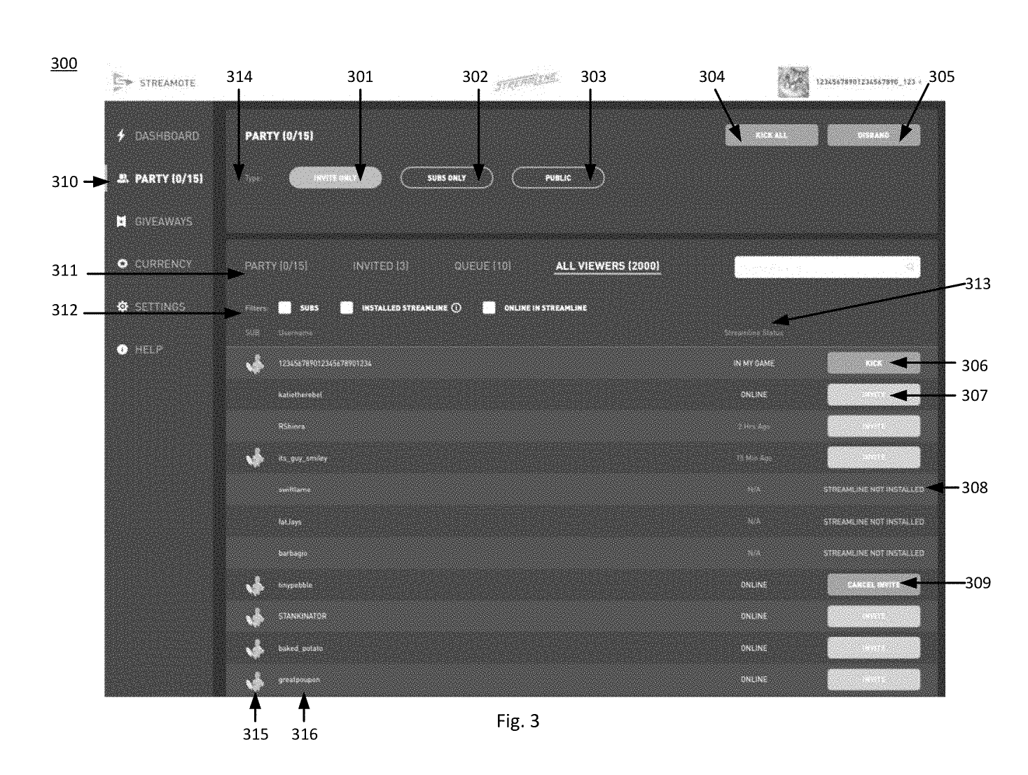

According to some embodiments, the broadcaster 102 can access an interface provided by the viewer controller system 108 at a broadcaster platform 105. The broadcaster platform 105 can include a device, such as a mobile device, a tablet, a personal computer, a gaming console, a TV, and/or any other suitable device(s). The broadcaster platform 105 can include one or more devices. The broadcaster platform 105 can receive the streaming data and/or other data from the viewer controller system 108, and present the data to the broadcaster 102 through an interface. In some embodiments, the broadcaster 105 can use the interface to watch the game played by the player 101 and/or makes live commentary on the game. In some embodiments, the interface can be accessible through a standalone application on the device of the broadcaster 102 at the broadcaster platform 105. In other embodiments, the interface is accessible through a web browser on the device of the broadcaster 102 at the broadcaster platform 105. The broadcaster 102 may need to log in to the viewer controller system 108 and/or another authentication system to access the interface. An example is a party interface 300 for the broadcaster 102 in FIG. 3, which is discussed more in detail below.

According to some embodiments, the broadcaster 102 can watch the game played by the player 101 in real time or substantially in real time. In other embodiments, there can be a delay between when the game is played by the player 101 and when the game is watched by the broadcaster 102. The number of broadcasters at 102 can be zero, one, or more than one.

According to some embodiments, a plurality of broadcasters at 102 can interact with the game using the same broadcaster platform 105. For example, two broadcasters can be sitting in the same room to watch a game using a big screen monitor connected to a computer, which can be a part of the broadcaster platform 105. One broadcaster can use a mouse, which can also be a part of the broadcaster platform 105, to adjust the size of the interface. The other broadcaster can use a keyboard, which can also be a part of the broadcaster platform 105, to enter text into a chat window. In some embodiments, the broadcaster 102 can be a person. In other embodiments, the broadcaster 102 can be a non-person entity, such as an application installed on the broadcaster platform 105 or on another system. In other embodiments, the broadcaster 102 can be a combination of one or more persons and one or more non-person entities. In some embodiments, a single broadcaster at 102 can use more than one broadcaster platform 105. In some embodiments, one or more broadcasters at 102 can enlist one or more moderators and/or administrators. The one or more moderators and/or administrators can be given access to set up a game party; and/or interact with the game by starting and/or ending viewer games, such as bingo. The one or more moderators and/or administrators can also be given access to the viewer controller system 108 and/or various parts of the broadcaster platform 105.

According to some embodiments, the viewer 103 can access an interface provided by the viewer controller system 108 using a viewer platform 106. In some embodiments, the viewer platform 106 can include a device, such as a mobile device, a tablet, a personal computer, a gaming console, a TV, and/or any other suitable device(s). The viewer platform 106 can include one or more devices. In some embodiments, the viewer platform 106 can receive the streaming data and/or other data from the viewer controller system 108 to present to the viewer 103 through an interface. In some embodiments, the viewer 103 can use the interface to watch the game played by the player 101 and/or make live commentary on the game through a chat window or any other communication mechanism. In some embodiments, the viewer interface can be accessible through a standalone application on the device of the viewer 103 at the viewer platform 106. In other embodiments, the interface can be accessible through a web browser on the device of the viewer 103 at the viewer platform 106. The viewer 103 may need to log in to the viewer controller system 108 and/or another authentication system to access the interface. An example is a viewer interface 400 in FIG. 4, which is discussed more in detail below.

According to some embodiments, the viewer 103 can watch the game played by the player 101 in real time or substantially in real time. In other embodiments, there can be a delay between when the game is played by the player 101 and when the game is watched by the viewer 103. The number of viewers at 103 can be zero, one, or more, including thousands, tens of thousands, hundreds of thousands, or millions of viewers. In some embodiments, a plurality of viewers at 103 can be located in disparate parts of the world and connected to the same viewer controller system 108 to interact and view the same game played by the player 101.

According to some embodiments, a plurality of viewers at 103 can interact with the game using the same viewer platform 106. For example, two viewers can be sitting in the same room to watch a game using a big screen monitor connected to a tablet, which can be a part of the viewer platform 106. One viewer can use a mouse, which can also be a part of the viewer platform 106, to adjust the size of the interface. The other viewer can use a tablet to enter an emoticon into a chat window. In some embodiments, the viewer 103 can be a person. In other embodiments, the viewer 103 can be a non-person entity, such as an application installed on the viewer platform 106 and/or on another system. In other embodiments, the viewer 103 can be a combination of one or more persons and one or more non-person entities. In some embodiments, a single viewer at 103 can use more than one viewer platform 106.

According to some embodiments, the viewer platform 106 can be connected to a payment system 109 via the internet, an intranet, and/or another type of network. In some embodiments, the viewer 103 can use the payment system 109 to make a purchase(s) necessary to perform a certain action(s), such as sponsoring a raid for the players 101 or the broadcaster 102. In some embodiments, the payment system 109 can also be connected to the viewer controller system 108 via the internet, an intranet, and/or another type of network. By having this connection, the viewer controller system 108 can receive payment information related to the purchase(s) by the viewer 103 directly from the payment system 109.

As described, FIG. 1 shows three types of users (101, 102, 103). While each user type can represent a distinct group of persons and/or systems, the same person or system can belong to more than one user type. For example, while the player 101 is playing a game, the player 101 can also act as the broadcaster 102 and broadcast using the broadcaster platform 105.

Moreover, as described, FIG. 1 shows three types of platforms (104, 105, 106) and three types of systems (107, 108, 109). While each platform and each system can be physically distinct, one or more of the platforms and/or systems can reside on the same physical system. For example, the viewer controller system 108 can be implemented on a computer(s), and the same computer(s) can be used by the broadcaster 102 to access the broadcaster platform 105 via a web browser.

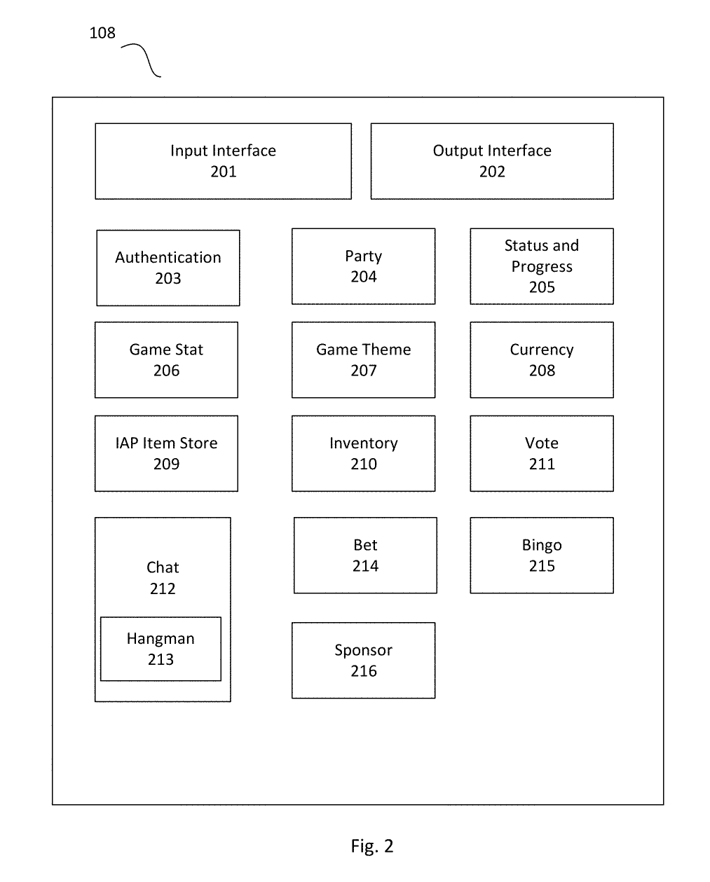

FIG. 2 is a block diagram illustrating various components of the viewer controller system 108 in accordance with some embodiments of the present disclosure. The viewer controller system 108 may or may not include all of these components. In some embodiments, the viewer controller system 108 can include additional components not shown in FIG. 2, less components than shown in FIG. 2, components divided into multiple components, components combined together, and/or any other suitable combination of components. FIG. 2 will be described with reference to FIGS. 3-12 and 15-22. FIG. 2 includes the following components: input interface 201, output interface 202, authentication 203, party 204, status and progress 205, game stat 206, game theme 207, currency 208, IAP item store 209, inventory 210, vote 211, chat 212, Hangman 213, bet 214, bingo 215, and sponsor 216.

According to some embodiments, the input interface component 201 can provide functionality related to receiving streaming data from the streaming data system 107. In some embodiments, the input interface component 201 can be configured to receive streaming data from one or more streaming data systems. For example, there can be two streaming data systems at 107, each of which hosts multiple games played by multiple players. The input interface 107 can be configured to receive the streaming data for all of these games.

According to some embodiments, the output interface component 202 can provide functionality related to streaming data to users of the viewer controller system 108. The streaming data can include some or all of the received streaming data at the input interface component 201 from the streaming data system 107. In some embodiments, the received streaming data at the input interface component 201 can be streamed to the users of the viewer controller system 108 in its raw form. In other embodiments, the received streaming data at the input interface component 201 can be partially or fully altered before streaming to the users via the output interface component 202. The received streaming data can be altered by a component within the viewer controller system 108 and/or by an external system(s).

According to some embodiments, the output interface component 202 can provide streaming data to one or more of different types of users, such as the broadcaster 102 and the viewer 103. The output streaming data provided to different types of users can be the same or different. In some embodiments, the output interface component 202 can use multiple channels to provide streaming data for multiple games played by multiple players 101. For example, the output interface component 202 can provide streaming data related to a first player playing a first game to a first group of broadcasters and a first group of viewers via a first channel, while providing streaming data related to a second player playing a second game to a second group of broadcasters and a second group of viewers via a second channel.

According to some embodiments, the output interface component 202 can provide streaming data to its users in real time, or substantially in real time. In other embodiments, a delay can exist between the player 101 playing the game and the user (e.g., broadcaster 102, the viewer 103) watching the player 101 playing the game. This delay can arise from a delay in some or all of the connections between (1) the player platform 104 and the streaming data system 107, (2) the streaming data system 107 and the viewer controller system 108, (3) the viewer controller system 108 and the broadcaster platform 105, (4) the viewer controller system 108 and viewer platform 106, and (5) any other systems that are involved in delivering the streaming data. This delay can also be caused by any processing within the player platform 104, streaming data system 107, viewer controller system 108, the broadcaster platform 105, the viewer platform 106, and/or any other system involved in delivering the streaming data.

According to some embodiments, the authentication component 203 can provide functionality related to authenticating the users of the viewer controller system 108. For example, the broadcaster 102 and/or the viewer 103 may need to log in to the viewer controller system 108 to view the game through an interface provided by the viewer controller system 108. The viewer controller system 108 can implement a native authentication system or leverage an external authentication system. For example, the native authentication system can comprise a local or remote database system, which keeps track of the user's login information, such as the user ID and password. The external authentication system can, for example, use a third-party authentication system, such as a user authentication system by TWITCH™, FACEBOOK™, GOOGLE™, and/or any other suitable user authentication system provider. For example, the viewer 103 can be required to login using a TWITCH™ account before being allowed to access the viewer interface. Administrators of the viewer controller system 108 can set various access levels and/or manage various access groups.

According to some embodiments, the party component 204 can provide functionality related to managing a party for a game. In some embodiments, the party refers to a group of viewers that are allowed to join a game. Functions related to managing a party can comprise inviting viewers, including viewers, and excluding viewers. For example, the broadcaster 102 can create a party for a game using a party interface 300 as shown with reference to FIG. 3. In some embodiments, the broadcaster 102 can designate a party type 314 to be one of the following three types: invite only 301, subscribers only 302, and public 303. If the party type is invite only 301, only the invited viewers can join the game. If the party type is subscribers only 302, only the subscriber viewers can join the game. Although not shown in FIG. 3, there can be other statuses of viewers other than the subscriber status. Another example of a viewer status is a follower. In some embodiments, a viewer can become a follower by clicking a “Follow” button on a game channel page. In some embodiments, the broadcaster 102 can choose to narrow the party by one or more statuses of the viewer. If the party type is public 303, the party can be open to all viewers.

The broadcaster 102 can invite a viewer to the party by clicking on an Invite button 307 associated with a viewer. In some embodiments, if the Invite button 307 is clicked, the button turns to a Cancel Invite button 309. In some embodiments, if the broadcaster 102 invites a viewer to the party, the invited viewer can receive the invitation on the viewer interface 400, as shown with reference to FIG. 4. If the invited viewer wants to become a member of the party, the invited viewer can accept the invitation by clicking on a Join Party button 401. If the invited viewer does not want to become a member of the party, the invited viewer can either ignore the invitation or decline the invitation by clicking on a Decline button 402. In some embodiments, if the invited viewer clicks on the Join Party button 401 or the Decline button 402, the broadcaster 102 can be notified that the invited viewer has either accepted or declined the invitation. In some embodiments, before the invited user accepts or declines the invitation, the broadcaster 102 can cancel the invitation by clicking on the Cancel Invite button 309 (shown in FIG. 3). In some embodiments, if the Cancel Invite button 309 is clicked, the button turns back to the Invite button 307 (shown in FIG. 3). In some embodiments, if the invited viewer accepts the invitation, the button turns to a Kick button 306. The broadcaster 102 can kick out the invited viewer from the party by clicking on the Kick button 306. If the broadcaster 102 clicks on the Kick button 306, the viewer may no longer join the game and the button for the viewer may change back to the Invite button 307.

According to some embodiments, the broadcaster 102 can kick out all the invited viewer(s) from the party by clicking on the Kick All button 304. In some embodiments, if the broadcaster 102 clicks on the Kick All button 304, all the invited viewer(s) can no longer join the game and each button for these viewer(s) can change back to the Invite button 307. In some embodiments, the broadcaster 102 can remove all players from the party and delete the party entirely by clicking on the Disband button 305.

According to some embodiments, the broadcaster 102 can open the party to only the subscribers on a given platform like TWITCH™ or GOOGLE™, to only the followers on a given platform like TWITCH™ or GOOGLE™, and/or to all the viewers. The broadcaster 102 can control this by designating a party to a specific type. For example, the subscribers only button 302 can be clicked to open the party to only the subscribers.

According to some embodiments, the maximum number of party members can be fixed. For example, the maximum number of party members at 310 shows that the party is limited to fifteen members. In other embodiments, the broadcaster 102 can set the maximum number of party members. In some embodiments, if the party has reached the maximum number of party members, viewers who are attempting to join the party (e.g., invited viewers that have accepted the invitation) can be placed in a queue.

In some embodiments, parties can be used for multiple games. In some embodiments, the party can become the basis for betting and/or voting options within a game.

According to some embodiments, the broadcaster 102 can manage a party—for example, by using control buttons such as 306, 307, and 309—for viewers that use a particular viewer controller system. For example, STREAMLINE™ is a type of a viewer controller system, developed by PROLETARIAT, INC (Boston, Mass.). If the party interface 300 is configured to work with only viewers that use the STREAMLINE™ viewer controller system, the party interface 300 can display a message, such as the “STREAMLINE NOT INSTALLED” message 308, for viewers that do not use the STREAMLINE™ viewer controller system. In some embodiments, viewers that do not use the STREAMLINE™ viewer controller system may not be invited to a party.

According to some embodiments, the broadcaster 102 can select to view only a group of viewers that satisfy a certain condition(s) (311), such as viewers who have joined the party (e.g., “PARTY (0/15)” in 300), viewers who have been invited to the party (e.g., “INVITED (3)” in 300), viewers who are waiting to join the party in the queue (e.g., “QUEUE (10)” in 300), all the viewers that can be seen by the viewer controller system (e.g., “ALL VIEWERS (2000)” in 300), and/or any other suitable condition.

According to some embodiments, the list of viewers shown in the party interface 300 can be narrowed by selecting one or more of filters 312. Examples of the filters 312 can include “SUBS” (displaying subscriber viewers), “INSTALLED STREAMLINE” (displaying viewers who are using the STREAMLINE™ viewer controller system), and “ONLINE IN STREAMLINE” (displaying viewers who are online and using the STREAMLINE™ viewer controller system).

According to some embodiments, the party interface 300 can provide status information related to the use of a viewer controller system. For example, the Streamline Status field 313 can show information about each viewer's use of the STREAMLINE™ viewer controller system. The status message(s) can comprise one or more of the following: “IN MY GAME” (indicating that the viewer is in the game that is being broadcasted), “ONLINE” (indicating that the viewer is online but not in the game that is being broadcasted), “X Units of Time Ago” (indicating that the viewer was last using the STREAMLINE™ viewer controller system X Unit(s) of Time Ago), and “N/A” (indicating that the viewer status is not available because the viewer has never used the STREAMLINE™ viewer controller system).

According to some embodiments, the party interface 300 can list usernames 316 of its users or viewers. Each username can be associated with an icon 315 if the user belongs to a specific group (e.g., a subscriber group).

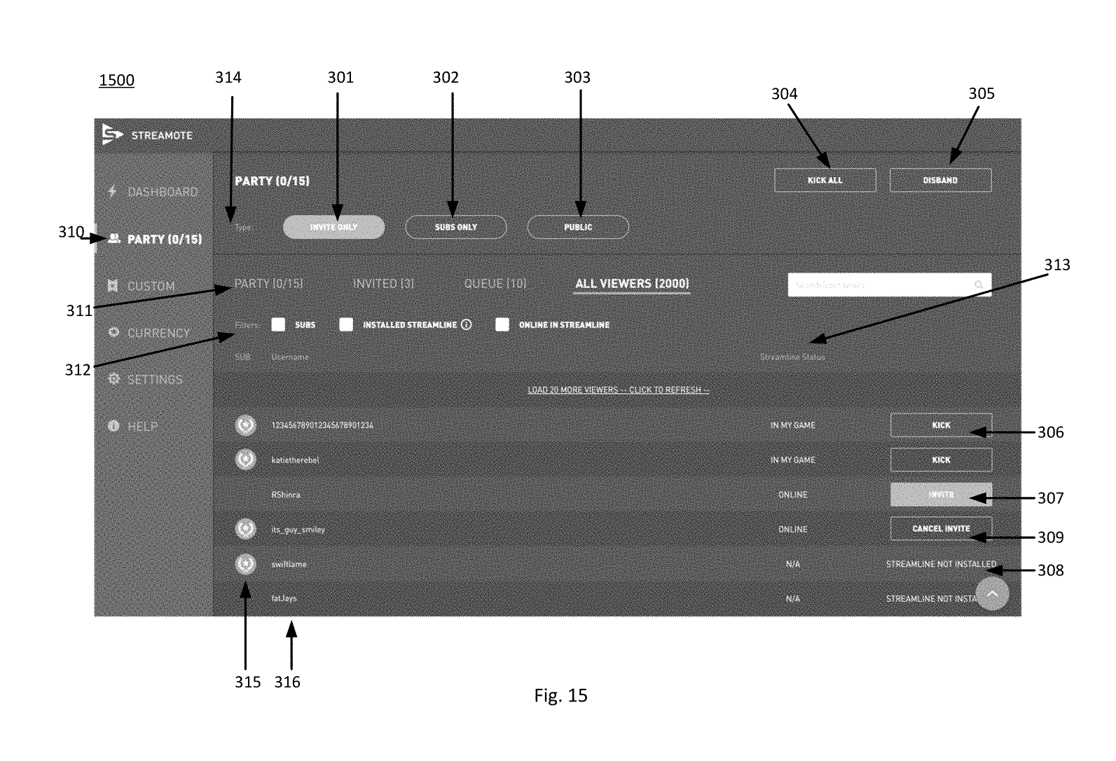

FIG. 15 shows a different party interface 1500 for a broadcaster in accordance with some embodiments of the present disclosure. In some embodiments, the party interface 1500 can include functionality similar to the party interface 300 (FIG. 3). For example, the same reference numerals in FIGS. 3 and 15 can refer to elements with the same or similar functionality.

According to some embodiments, referring back to FIG. 2, the status and progress component 205 can provide functionality related to providing personal status and progress in a given game, such as a player level and/or rank.

According to some embodiments, the game stat component 206 can provide functionality related to presenting game stats. In some embodiments, the game stats can be specific to games. For example, game stats can include the total points earned, the number of wins, the number of remaining lives, the amount of remaining energy level, the best score, the shortest time to finish a lap, the longest time to finish a lap, the average time to finish a lap, and/or any other suitable stat related to a specific game.

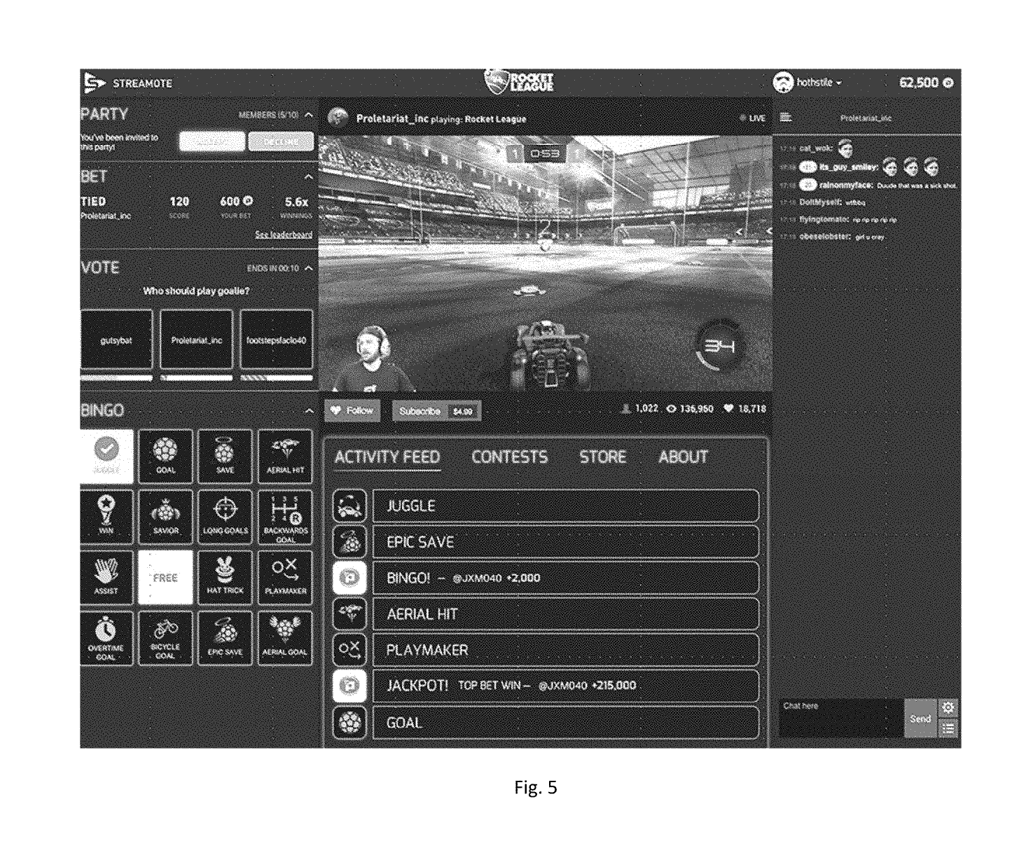

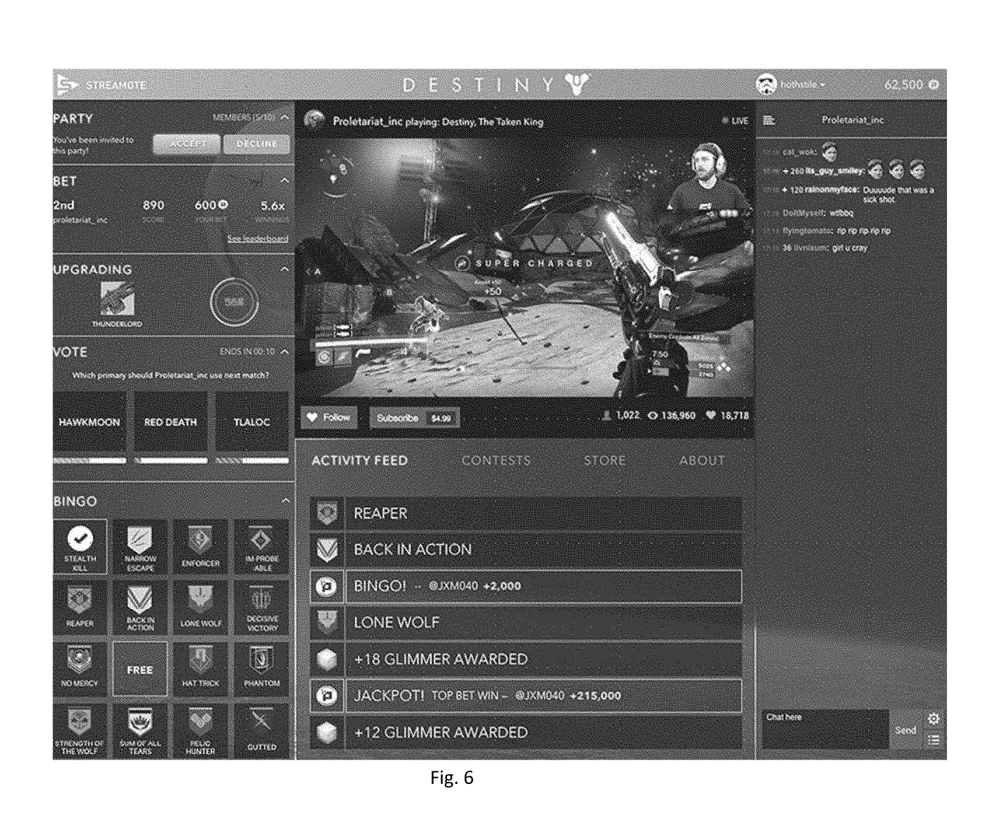

According to some embodiments, the game theme component 207 can provide functionality related to customizing the experience of the broadcaster 102 and/or the viewer 103. For example, the game theme component 206 can allow the layout and the skin color or pattern of the viewer interface to be customized. For example, FIGS. 5 and 6 are illustrative screenshots of viewer interfaces in accordance with some embodiments of the present disclosure, where the viewer interfaces are used for two different games. These viewer interfaces use different logos, colors, and layout.

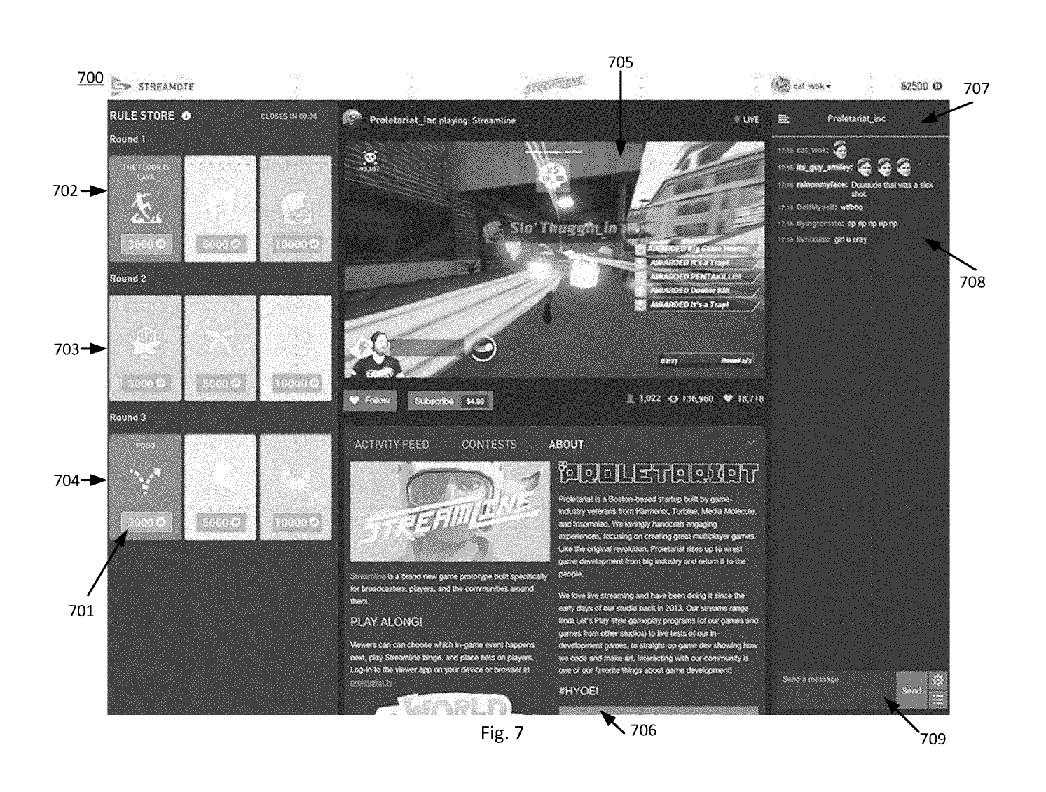

According to some embodiments, the currency component 208 can provide functionality related to creating and/or customizing a currency. In some embodiments, the currency can be created and/or customized for each channel. In some embodiments, the currency can be used within a loyalty point system for the viewer 103. By using points, the viewer 103 can perform transactions at a channel currency store 700 as shown with reference to FIG. 7. As an example, the channel currency store 700 can list nine items for sale for points. Different items can be associated with a different game round: three items (702) can be associated with Round 1; three items (703) can be associated with Round 2; and three items (704) can be associated with Round 3. Each item can have a name, a symbol, and/or a purchase price. For instance, one of these nine items is a Pogo 701, which sells for 3000 points. In some embodiments, the viewer 103 can access the channel currency store 700 and purchase the Pogo 701 if the viewer 103 has 3000 or more points. A purchase can be made by clicking on an item and following any other steps if any.

According to some embodiments, the channel currency store 700 can provide a game viewing section 705 (which can be the same as the streaming data section 406 (FIG. 4) in some embodiments), an information section 706, and/or a chatting section 707. The information section 706 can provide various types of information. For example, the information can be about the game and/or the maker of the game. The chatting section 707 can include content of a chat 708, which can include text previously entered by one or more users; and a text entering section 709, which a user can use to enter text into the chat.

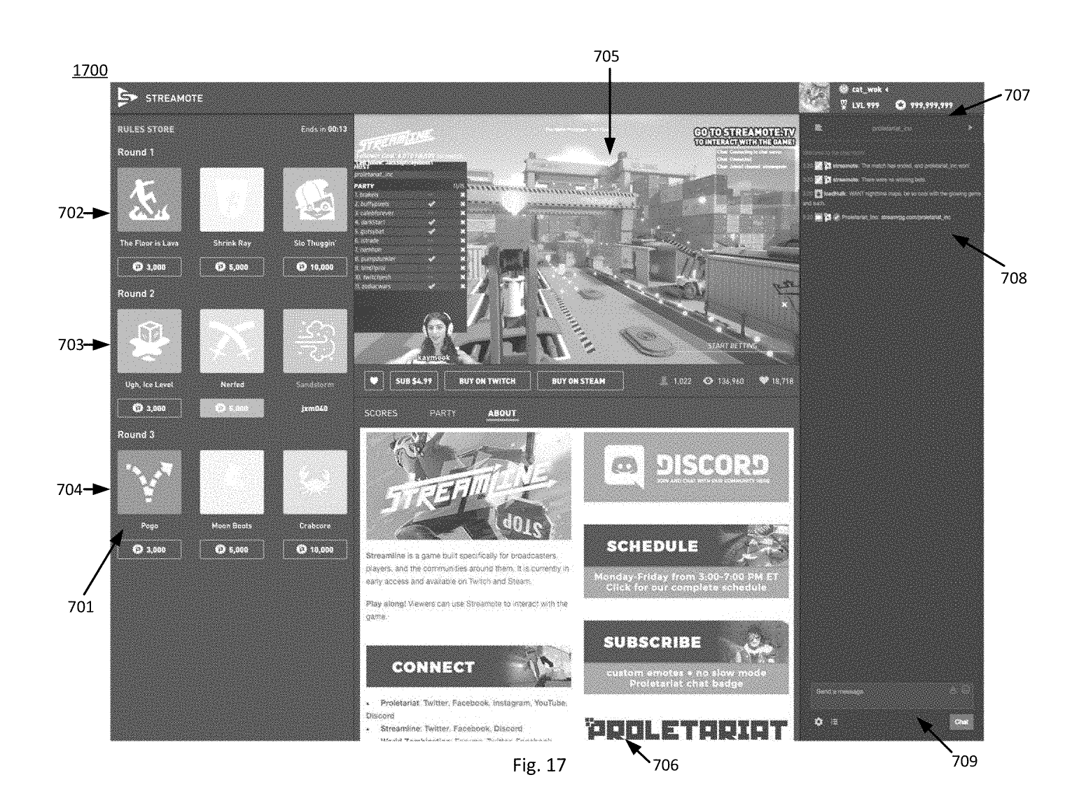

FIG. 17 shows a different channel currency store 1700 in accordance with some embodiments of the present disclosure. In some embodiments, the channel currency store 1700 can include functionality similar to the channel currency store 700 (FIG. 7). For example, the same reference numerals in FIGS. 7 and 17 can refer to elements with the same or similar functionality.

According to some embodiments, objectives of using loyalty points can include enhancing the viewers' engagement with the game and/or interaction with the viewer controller system 108. In some embodiments, a monetization goal(s) can be implemented and/or realized. For example, the viewer 103 may need a certain amount of the currency to view and/or interact with the game using the viewer controller system 108. In some embodiments, the broadcaster 102 has the currency—for example, in the form of virtual coins—that the broadcaster 102 can use to incentivize the player, such as by auctioning off exclusive access to the party, and/or customized recognition such as reading a message from the player 103.

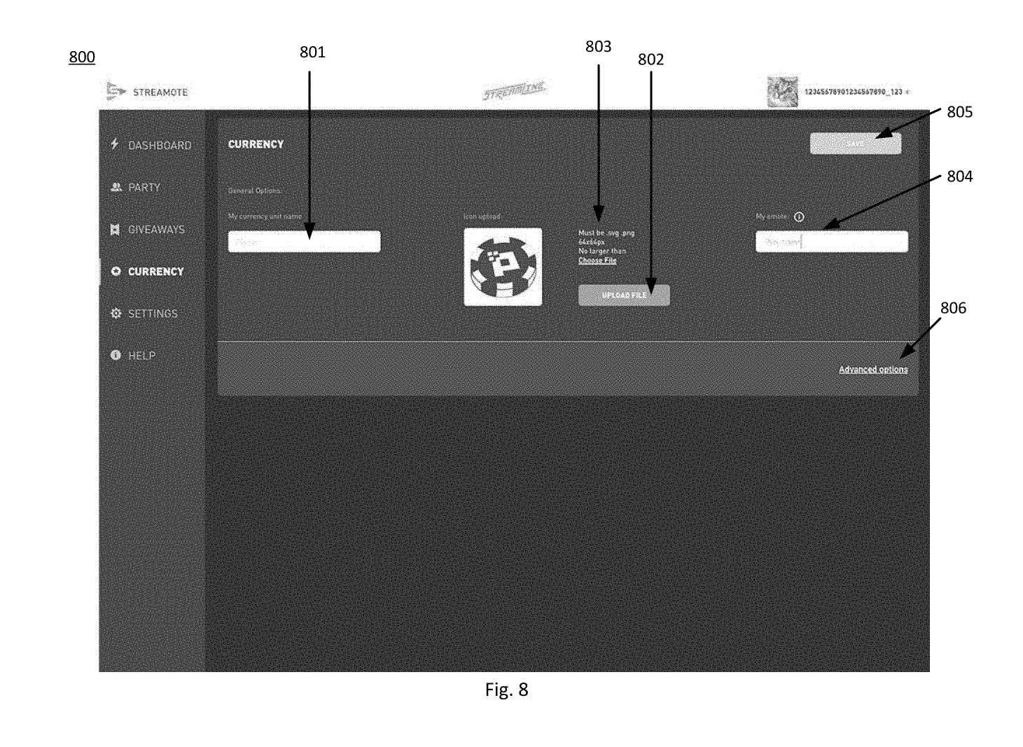

According to some embodiments, the broadcaster 102 for a channel can customize a currency for the channel by using a currency interface 800, as shown with reference to FIG. 8. For example, the broadcaster 102 can specify the currency unit name 801 and/or upload an image/icon associated with the currency by using the Upload File button 802. The currency interface 800 can provide a restriction(s) 803 (e.g., allowed file type(s), the minimum file size, the maximum file size) for the file that can be uploaded. If the viewer controller system 108 allows for emotes, such as TWITCH™ emotes, the broadcaster 102 can create or specify an emote for the currency for the broadcaster's channel. For example, the emote can be specified under the field “My emote” 804. In some embodiments, the emote can be displayed in status messages on the viewer controller interface displayed to viewers at the viewer platform 106. In some embodiments, the broadcaster 102 can save a change(s) made using the currency interface 800 by pressing the SAVE button 805. In some embodiments, the currency interface 800 can provide an advanced option(s) 806 for setting and/or customizing the currency.

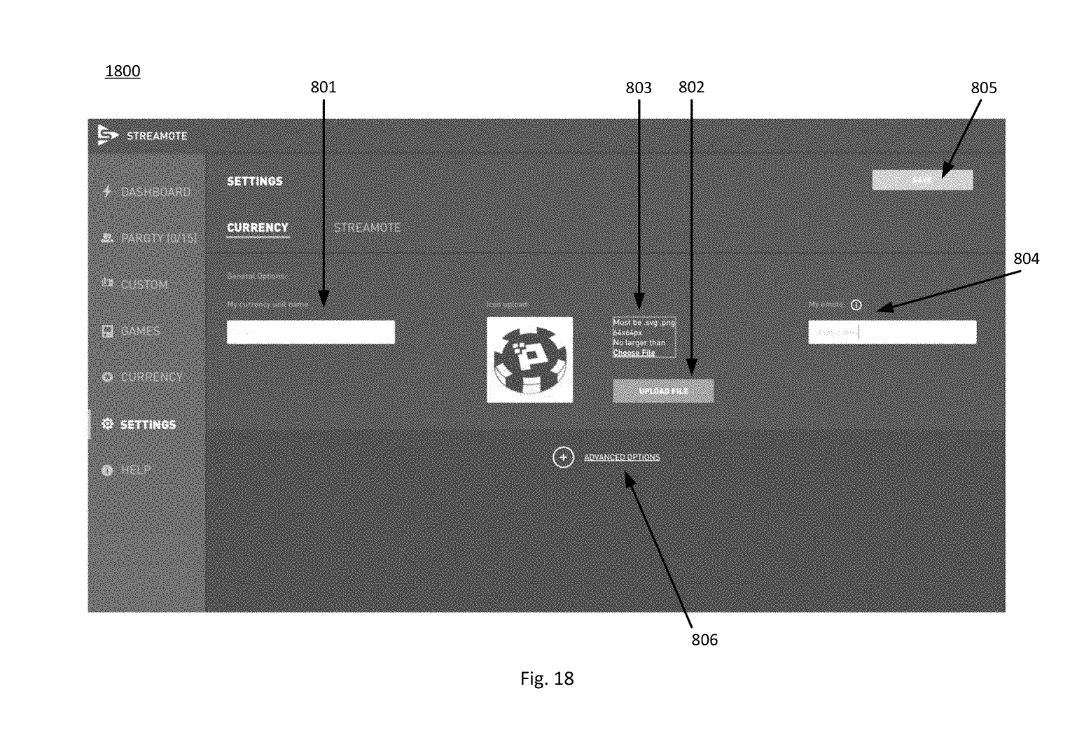

FIG. 18 shows a different currency interface 1800 for a broadcaster in accordance with some embodiments of the present disclosure. In some embodiments, the currency interface 1800 can include functionality similar to the currency interface 800 (FIG. 8). For example, the same reference numerals in FIGS. 8 and 18 can refer to elements with the same or similar functionality.

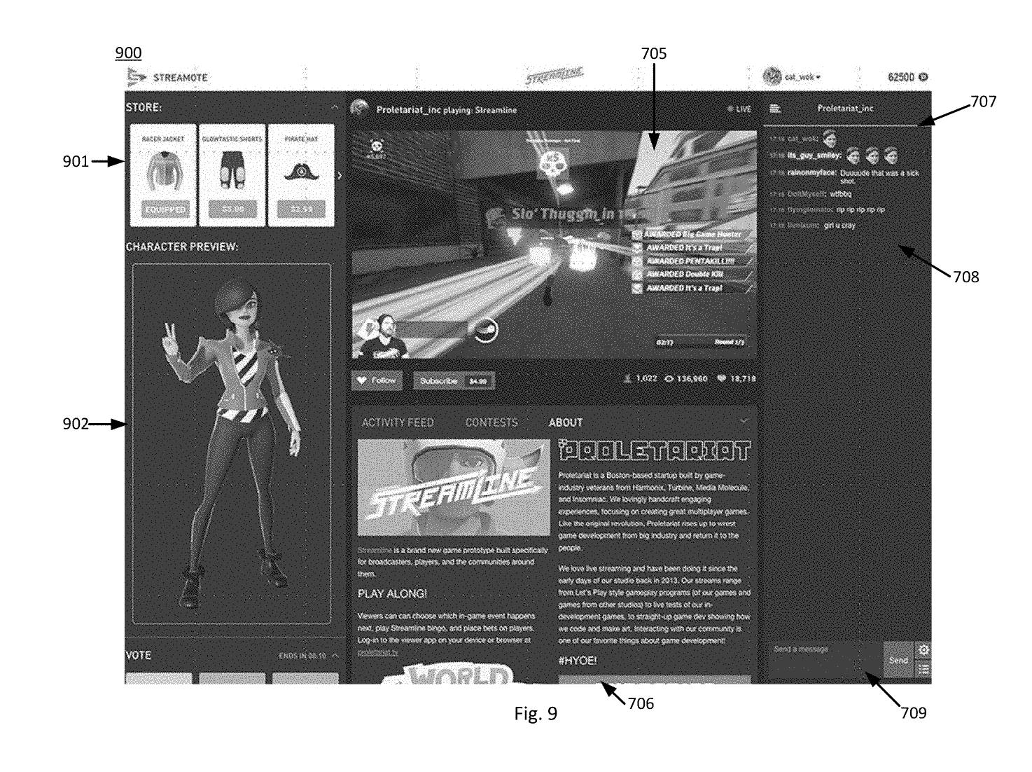

According to some embodiments, referring back to FIG. 2, the IAP item store component 209 can provide functionality related to purchasing items for the viewer 103. For example, the viewer can go to an IAP store 900, as shown with reference to FIG. 9, to purchase an item for a character. In some embodiments, the IAP store 900 can be an affiliate store for the broadcaster 102 to sell a game item(s). In some embodiments, the IAP store 900 can offer one or more items for purchase. For example, the IAP store 900 can offer three items 901, each of which can have a name, an image, a price, and/or status. The status of an item can indicate whether a character already has the item. In some embodiments, if the character already has the item, the item price may not show, and the item status may be shown as “EQUIPPED.” In some embodiments, a character preview section 902 can show how a character can look with a specified item(s).

According to some embodiments, the IAP item store interface can provide a game viewing section 705, an information section 706, and/or a chatting section 707 with content of a chat 708 and a text entering section 709, similar to the channel currency store 700 (FIG. 7).

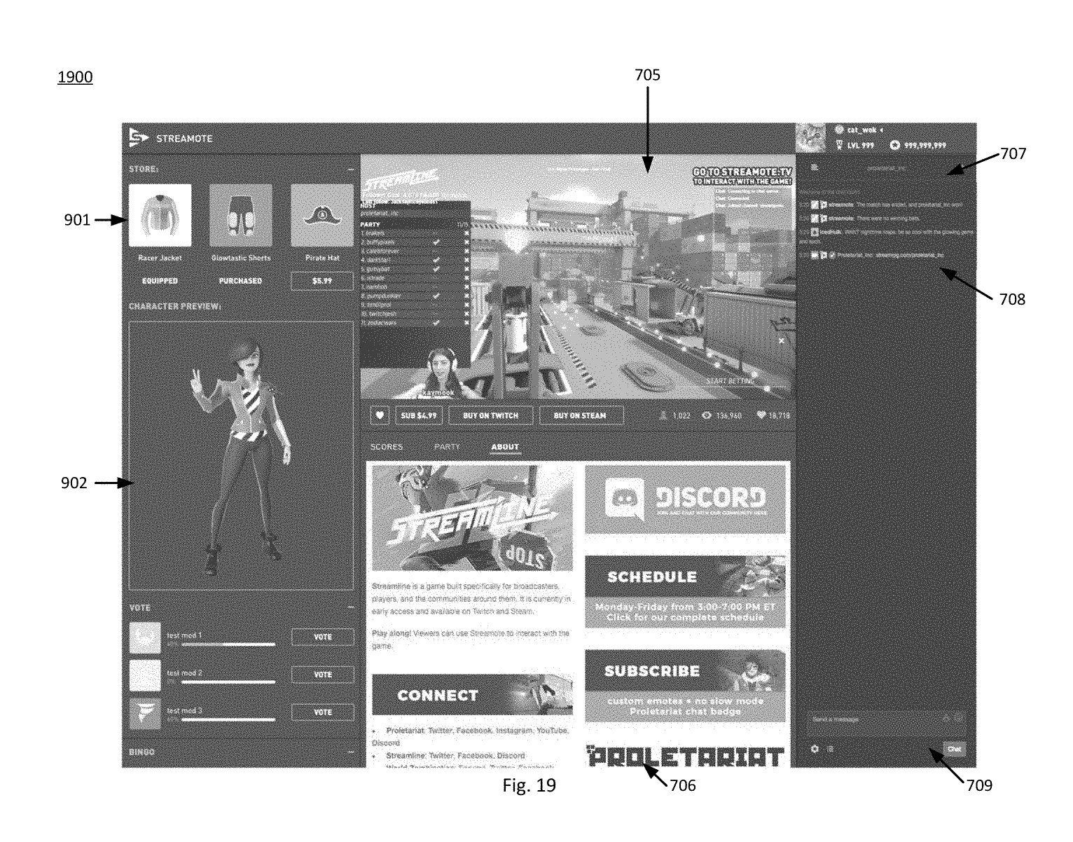

FIG. 19 shows a different IAP store 1900 in accordance with some embodiments of the present disclosure. In some embodiments, the IAP store 1900 can include functionality similar to the IAP store 900 (FIG. 9). For example, the same reference numerals in FIGS. 9 and 19 can refer to elements with the same or similar functionality.

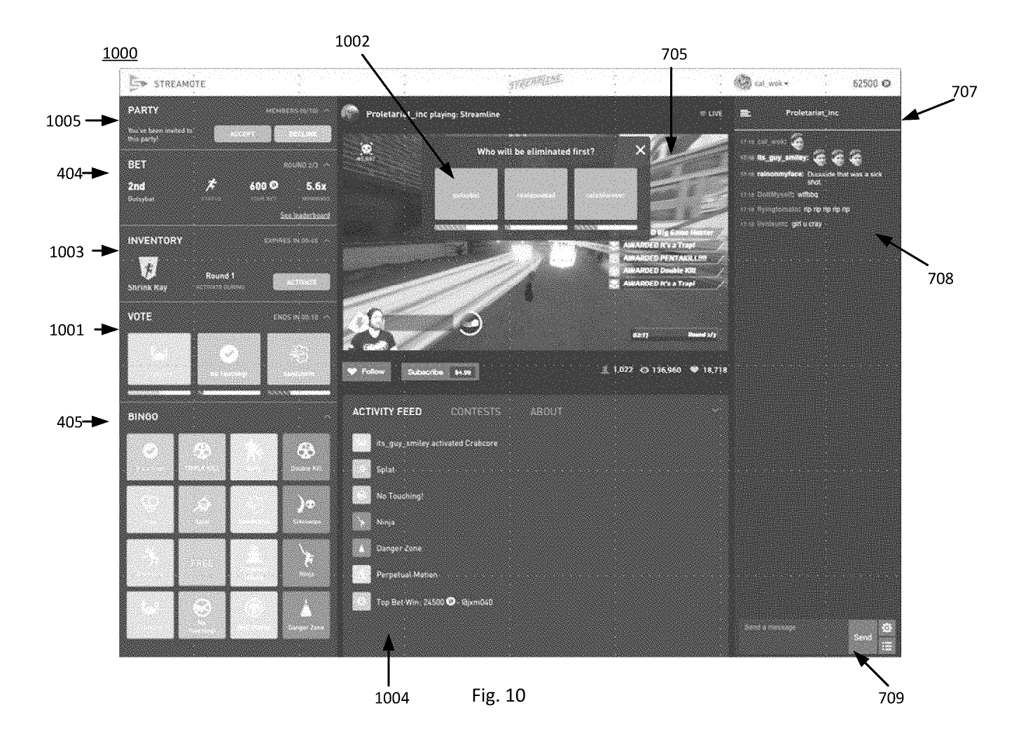

According to some embodiments, referring back to FIG. 2, the inventory component 210 can provide functionality related to the inventory of item(s) for the viewer 103. In some embodiments, the viewer interface 1000, as shown with reference to FIG. 10, can include an inventory section 1003 to show the items the viewer 103 may have. If an item is activatable, the item can be activated through the inventory section 1003. This item can be experiential in nature causing a specific event to occur in the given game. In some embodiments, an item(s) can cause a change to a rule(s), such as a game rule(s). In some embodiments, the item(s) can impact a specific player(s) by, for example, providing a change in the power, such as power up.

According to some embodiments, the viewer interface 1000 can provide a game viewing section 705 and/or a chatting section 707 with content of a chat 708 and a text entering section 709, similar to the channel currency store 700 (FIG. 7). In some embodiments, the viewer interface 1000 can provide a bet section 404 and/or a bingo section 405, similar to the viewer interface 400 (FIG. 4). In some embodiments, the viewer interface 1000 can provide an activity feed section 1004, where information on various types of activities by users and/or systems can be provided. In some embodiments, the viewer interface 1000 can provide a party section 1005, where the viewer can accept or decline a party to which the viewer has been invited. The party section 1005 can further provide information on the party, such as the total number of members of the party and the maximum allowable size of the party.

According to some embodiments, referring back to FIG. 2, the vote component 211 can provide functionality related to managing voting on the viewer interface. In some embodiments, the viewers 103 can be asked to vote on any matter or question related to any topic by the broadcaster 102 and/or another user of the viewer controller system 108. For example, as shown with reference to FIG. 10, a viewer interface 1000 shows a voting section 1001, where the viewer can vote for one of the three characters. As another example, the viewer interface 1000 shows a question for the viewer, and the viewer is asked to select one of the three answers to the questions (1002). In some embodiments, the voting can take place to take a survey.

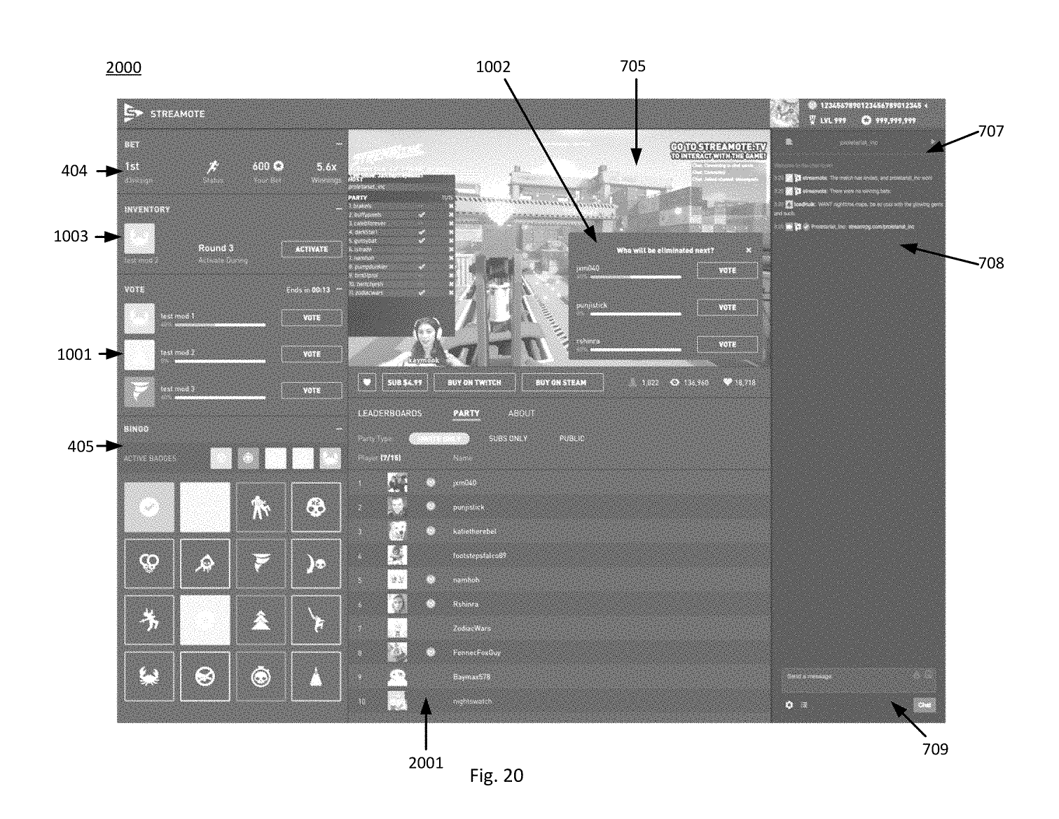

FIG. 20 shows a different viewer interface 2000 that includes functionality similar to FIG. 10 in accordance with some embodiments of the present disclosure. In some embodiments, the viewer interface 2000 can include functionality similar to the viewer interface 1000 (FIG. 10). For example, the same reference numerals in FIGS. 10 and 20 can refer to elements with the same or similar functionality. In some embodiments, the viewer interface 2000 can display information 2001 about members of the party for the game. For example, such information can include the members' usernames, indications on whether they are subscribers, the total number of members of the party, and the maximum allowable size of the party.

According to some embodiments, referring back to FIG. 2, the chat component 212 can provide functionality related to providing and/or managing a chatting service(s) for the user(s) of the viewer controller system 108. For example, as shown with reference to FIG. 4, the viewer interface 400 shows a chat window 403. The broadcaster 102 and/or the viewer 103 can customize the chat window 403 by using a skin. In some embodiments, the skin can match the brand of the game. In some embodiments, the game progression can be inserted into the chat window 403 by the broadcaster 102, the viewer 103, and/or any other person or system authorized to add such information to the chat window 403. In some embodiments, the broadcaster 102 and/or the viewer 103 can have multiple levels of status, including Online, Offline, Away, Busy, Do Not Disturb, and/or Invisible. In some embodiments, standard emotes, custom emotes, and/or emoticons can be available to the user(s) of the chat window 403. Emotes, such as an example emote 407, can come from a specific system or platform, such as TWITCH™. Emotes can also be custom-made for a specific viewer controller system and/or viewer platform, such as STREAMOTE™.

According to some embodiments, referring back to FIG. 2, the Hangman game 213 can be played within the chat window 403. In other embodiments, one or more of other games can be played within the chat window 403. For example, these other games can include a code deciphering game using emotes to create a pattern, trivia games, Twenty Questions, and/or any other suitable game.

According to some embodiments, the bet component 214 can provide functionality related to managing bets placed for a game. As shown with reference to FIG. 4, the viewer interface 400 can include a bet section 404, which can show, for example, that the viewer 103 placed a bet of 600 units on the player named “Gutsybat” (ranking the 4th), where the potential winning is 5.6 times the amount of the bet. In some embodiments, the viewer 103 can bet on a specific team to win and/or lose a given match, or bet on a specific player to win and/or lose. In some embodiments, a bet can be placed before the match starts using the broadcaster's channel currency discussed above. The bet can also be based on other viewers' bets, from which the total pool can be calculated. From the total pool, a fixed amount (e.g., a dollar amount, a percentage amount, or a combination of a dollar amount and a percentage amount) can be taken away—for example, as a commission. The rest of the amount in the pool can be redistributed to the winning viewers after the match is completed.

According to some embodiments, referring back to FIG. 2, the bingo component 215 can provide functionality related to managing a bingo game on a viewer interface. As shown with reference to FIG. 4, the viewer interface 400 can include a bingo section 405, which shows a bingo card with, for example, sixteen squares arranged in four columns and four rows. Each square can include a symbol and/or text. In some embodiments, all the squares can be unique. In other embodiments, two or more squares can be the same. The number of squares and/or their arrangement can be customizable. In some embodiments, with the exception of the “Free” square, each square can correspond to an event that can occur within the game. Whenever an event occurs, the corresponding square can be marked. In some embodiments, the first viewer to complete a row, column, and/or a diagonal wins the bingo game. In some embodiments, the winning viewer can receive a prize. In some embodiments, all the viewers at 103 can receive a unique bingo card. In other embodiments, some or all the viewers at 103 can receive the same bingo card.

In some embodiments, the viewer controller system 108 can include other game components beside the bingo component 215. For example, these other game components can include a puzzle game, a trivia game, and/or a character guessing game where the viewer 103 can guess a specific player's character based on clues.

According to some embodiments, the viewer interface 400 can provide a voting section 1001 similar to FIG. 10 and an information section 2001 similar to FIG. 20.

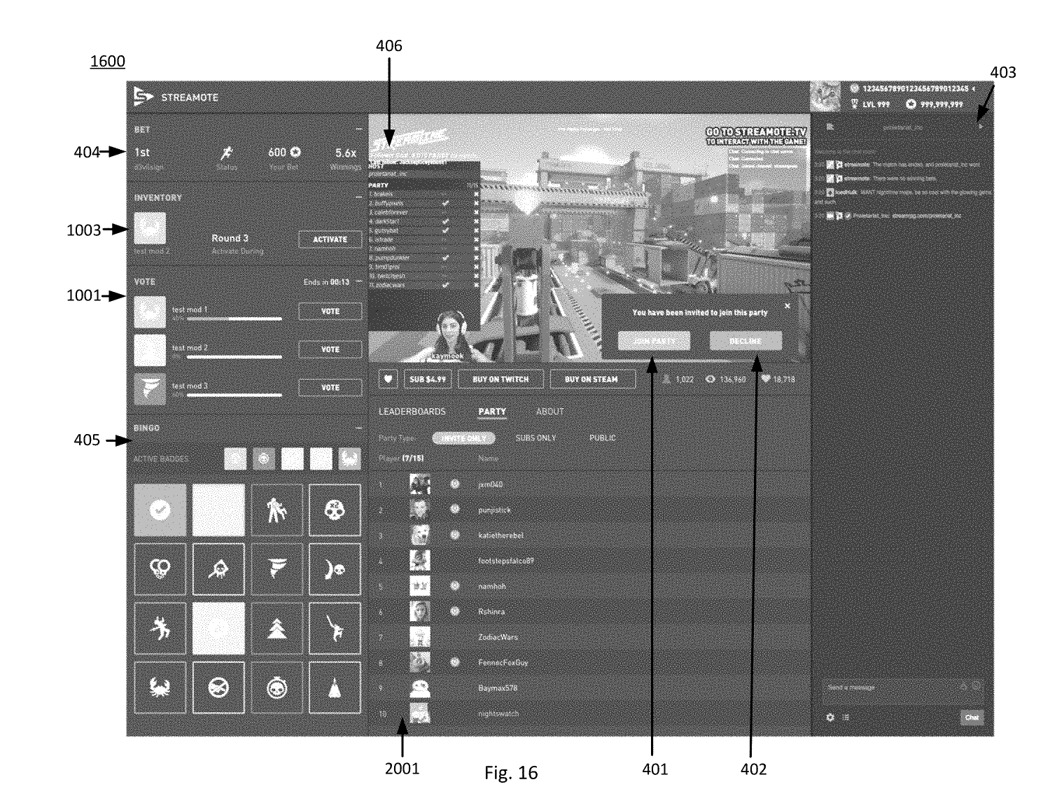

FIG. 16 shows a different viewer interface 1600 that includes functionality similar to FIG. 4 in accordance with some embodiments of the present disclosure. In some embodiments, the viewer interface 1600 can include functionality similar to the viewer interface 400 (FIG. 4). For example, the same reference numerals in FIGS. 4 and 16 can refer to elements with the same or similar functionality. The viewer interface 1600 can also include an inventory section 1003 similar to FIG. 10.

According to some embodiments, referring back to FIG. 2, the sponsor component 216 can provide functionality related to managing a viewer-sponsored game. The viewer 103 can sponsor a raid, match, arena run, and/or any part or session of a game through the sponsor component 216. In some embodiments, by sponsoring a game, the shout out for a viewer can be enhanced, for example, with the viewer's username displayed prominently in the viewer interface of the game for the duration of the sponsorship. In some embodiments, the sponsoring viewer can receive a reward(s). In some embodiments, the broadcaster 102 can dedicate the sponsored part and/or session of the game to the sponsoring viewer. In some embodiments, a custom tag can be placed on rewards won by the sponsors. The custom tag can act as an autograph.

In some embodiments, to further enhance the viewers' interaction with the viewer controller system 108, there can be other components, such as those that support functionality related to auctions and raffles.

In some embodiments, to guarantee accuracy of data regardless of any video delay, the viewer controller system 108 can use timestamps associated with streaming data from the streaming data system 107. For example, the viewer controller system 108 can leverage timestamped streaming video from TWITCH™. In some embodiments, the viewer controller system 108 can synchronize data such that even if there is a bad connection at any network, the accuracy of the data can be maintained, and any technical issues with the user experience can be reduced or eliminated.

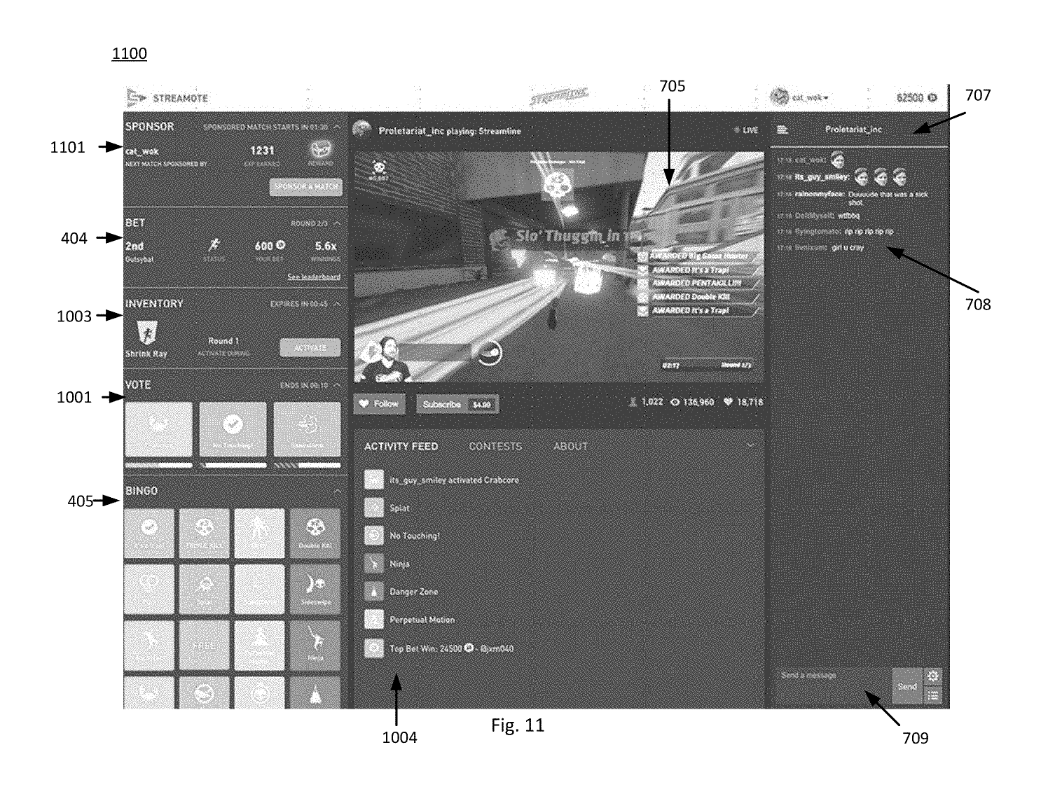

FIG. 11 is an illustrative screenshot of a viewer interface 1100 in accordance with some embodiments of the present disclosure. In some embodiments, the viewer interface 1100 can include a sponsor section 1101. The sponsor section 1101 can show the current sponsor to the viewer. The viewer can also sponsor a match by clicking on the Sponsor a Match button in the sponsor section 1101.

According to some embodiments, the viewer interface 1100 can provide a game viewing section 705 and/or a chatting section 707 with content of a chat 708 and a text entering section 709, similar to the channel currency store 700 (FIG. 7). In some embodiments, the viewer interface 1100 can provide a bet section 404 and/or a bingo section 405, similar to the viewer interface 400 (FIG. 4). In some embodiments, the viewer interface 1100 can provide a voting section 1001, an inventory section 1003, and/or an activity feed section 1004, similar to the viewer interface 1000 (FIG. 10).

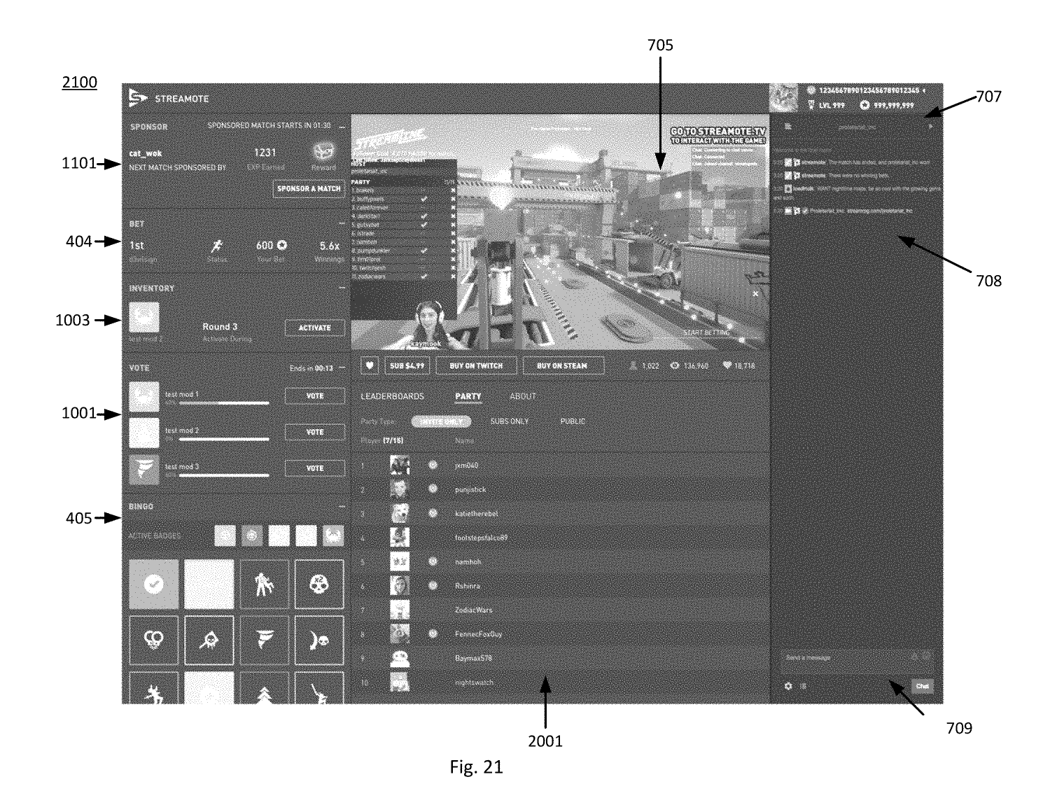

FIG. 21 shows a different viewer interface 2100 that includes functionality similar to FIG. 11 in accordance with some embodiments of the present disclosure. In some embodiments, the viewer interface 2100 can include functionality similar to the viewer interface 1100 (FIG. 11). For example, the same reference numerals in FIGS. 11 and 21 can refer to elements with the same or similar functionality. In some embodiments, the viewer interface 2100 can include an information section 2001 similar to FIG. 20.

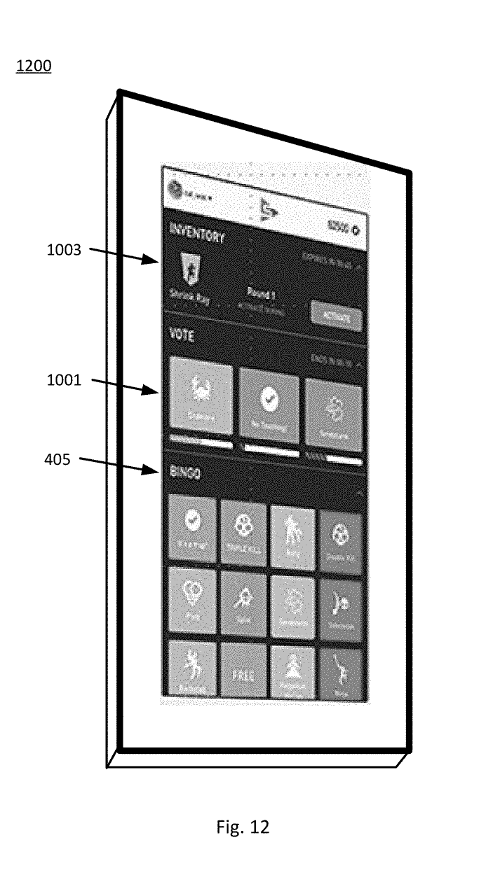

FIG. 12 is an illustrative screenshot of a viewer interface 1200 on a mobile device in accordance with some embodiments of the present disclosure. The viewer interface 1200 can include an inventory section 1003 (similar to the viewer interface in FIG. 10), a voting section 1001 (similar to the viewer interface in FIG. 10), a bingo section 405 (similar to the viewer interface in FIG. 4), and/or any other suitable sections, including those described herein.

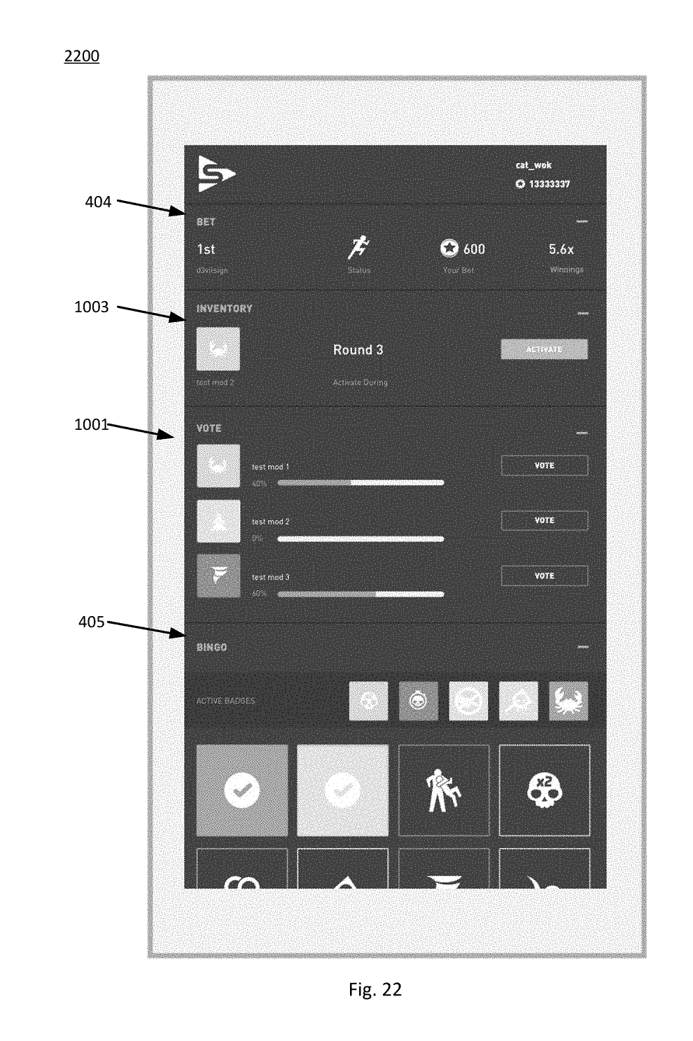

FIG. 22 is an illustrative screenshot of a viewer interface 2200 on a mobile device in accordance with some embodiments of the present disclosure. The viewer interface 2200 can include a bet section 404 (similar to the viewer interface in FIG. 4), an inventory section 1003 (similar to the viewer interface in FIG. 10), a voting section 1001 (similar to the viewer interface in FIG. 10), a bingo section 405 (similar to the viewer interface in FIG. 4), and/or any other suitable sections, including those described herein.

The layout of the viewer interfaces 1200 and 2200 can be customized to be compatible with the mobile device.

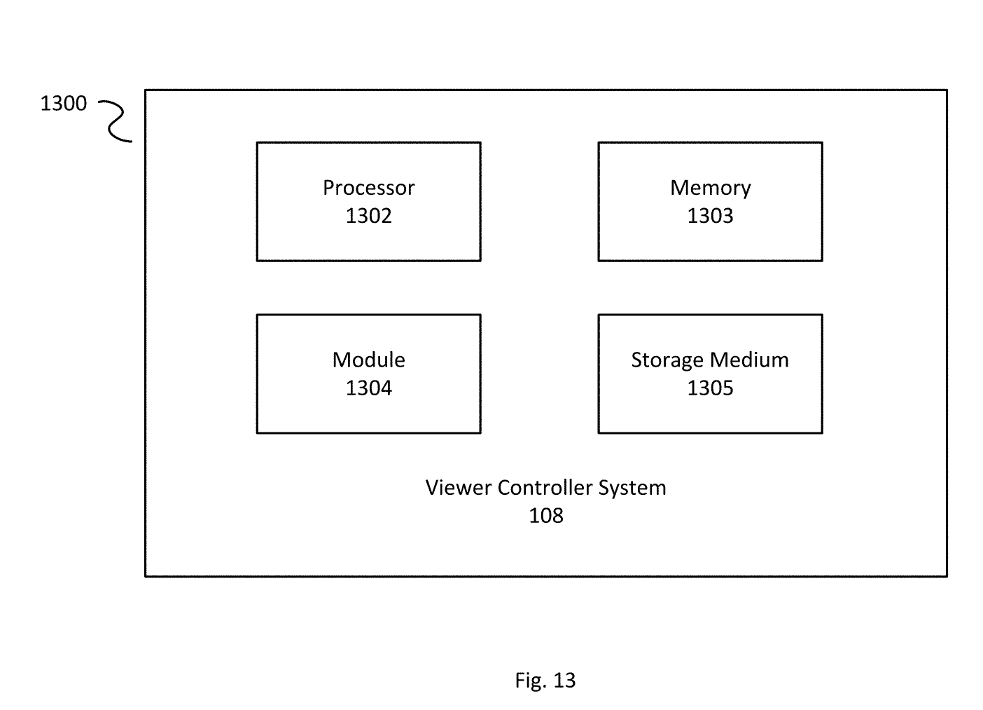

FIG. 13 is a block diagram illustrating a system 1300 that includes the viewer controller system 108 (FIG. 1) in accordance with some embodiments of the present disclosure. The viewer controller system 108 can include a processor 1302, a memory 1303, a module 1304, and/or a local storage medium 1305. The viewer controller system 108 can also communicate with a remote storage medium. The viewer controller system 108 can include additional modules, fewer modules, or any other suitable combination of modules that perform any suitable operation or combination of operations.

According to some embodiments, the processor 1302 can be configured to implement the functionality described herein using computer executable instructions stored in temporary and/or permanent non-transitory memory. The processor can be a general purpose processor and/or can also be implemented using an application specific integrated circuit (ASIC), programmable logic array (PLA), field programmable gate array (FPGA), and/or any other integrated circuit. The processor 1302 can execute an operating system that can be any suitable operating system (OS), including a typical operating system, such as any version or type of Windows, Mac OS, Unix, Linux, VXWorks, Android, Blackberry OS, iOS, Symbian, or other OS. The processor 1302 can also execute any instructions from web-server related hardware and/or software.

According to some embodiments, the module 1304 can be configured to cause the processor 1302 to execute functions related to the features of the viewer controller system 108 disclosed herein. For example, the module 1304 can be configured to cause the processor 1302 to process data. As a specific example, the module 1304 can use the processor 1302 to execute instructions to: receive, from a player platform, first data associated with a game played at the player platform; generate second data based on the first data, wherein the second data enables a viewer platform to provide one or more game participation features associated with the game to a viewer; transmit, to the viewer platform, the second data; receive, from the viewer platform, third data based on the second data, wherein the third data is based on an interaction of the viewer with the one or more game participation features associated with the game; generate fourth data based on the third data, wherein the fourth data enables the player platform to alter the game based on the interaction of the viewer with the one or more game participation features associated with the game; and transmit, to the player platform, the fourth data.

According to some embodiments, the module 1304, any part of the module 1304, or any other modules or components within the viewer controller system 108 can be implemented as software and/or hardware. In some embodiments, the module 1304 can be implemented in software using the memory 1303. The memory 1303 can be a non-transitory computer readable medium, flash memory, a magnetic disk drive, an optical drive, a programmable read-only memory (PROM), a read-only memory (ROM), or any other memory or combination of memories. In some embodiments, the memory can include a local storage medium 1305 and/or a remote storage medium. The memory 1303 can include data, such as information on users (e.g., a player, a broadcaster, and a viewer), information on other systems (e.g., a streaming data system, a player platform, a broadcaster platform, a viewer platform, and a payment system), and/or any other types data.

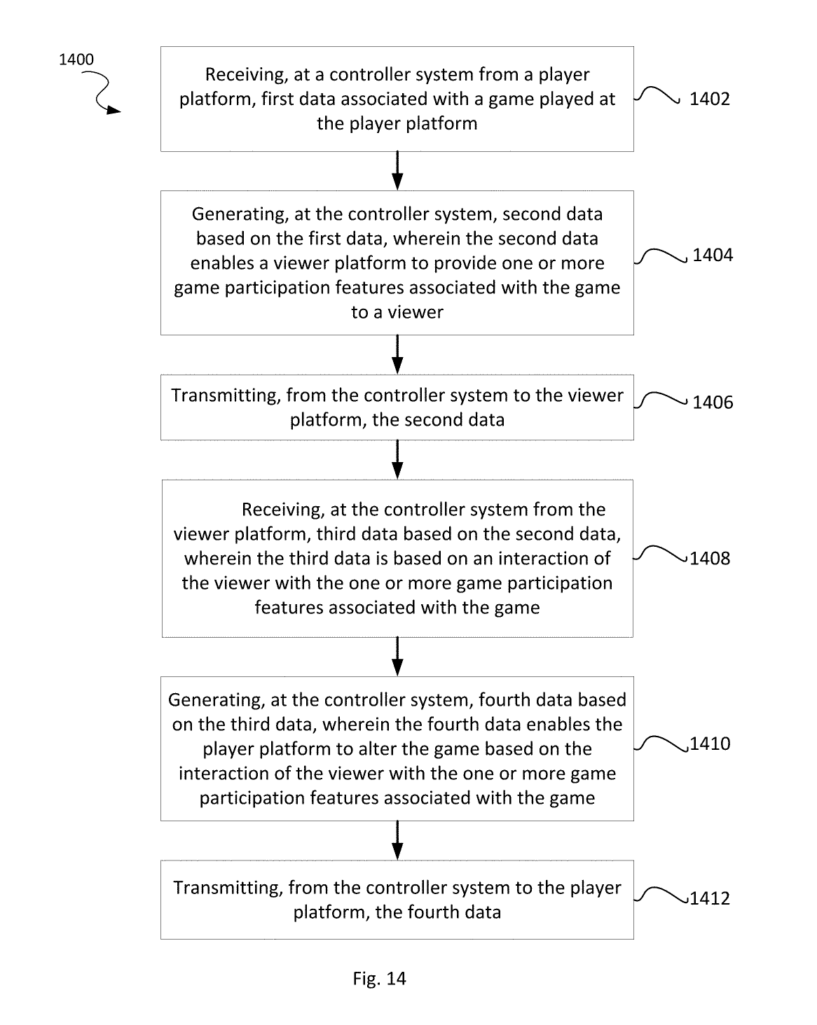

FIG. 14 is a flow chart illustrating a method 1400 for controlling a game in accordance with some embodiments of the present disclosure. In some embodiments, the method 1400 can be modified by, for example, having steps combined, divided, rearranged, changed, added, and/or removed. In some embodiments, the method 1400 can be performed at a controller system, such as the viewer controller system 108 shown in FIG. 1.

At step 1402, first data associated with a game played at a player platform can be received at a controller system from the player platform. In some embodiments, the first data can be streaming data. In some embodiments, the streaming data can be received from a streaming data system that is connected to the player platform. In some embodiments, the game played at the player platform can be at least one of: a multiplayer online game, a simulation game, an adventure game, a strategy game, an action game, a first person shooter game, a sport game, a war game, a racing game, a role-playing game, a puzzle game, and/or any other suitable game.

At step 1404, second data can be generated based on the first data at the controller system. In some embodiments, the second data can enable a viewer platform to provide a game participation feature(s) associated with the game to a viewer. In some embodiments, the second data can enable the viewer platform to display the game in real time or substantially in real time. In some embodiments, game participation features can include at least one of: a game altering feature, chatting, voting, sponsoring, placing a bet, playing a sub-game, purchasing an item, and/or any other suitable game participation feature. In some embodiments, the game altering feature can include at least one of: changing a rule of the game, voting for a change to the game, impacting a specific player of the game, and/or any other suitable game altering feature. In some embodiments, a type of the game can determine the game participation feature(s) that is associated with the game. For example, a puzzle game may allow a rule of the game to change but may not allow only a specific player of the game to be impacted. As another example, a first person shooter game may allow a specific player of the game to be impacted but may not allow viewers to vote for a change to the game.

At step 1406, the second data can be transmitted from the controller system to the viewer platform.

At step 1408, third data can be received at the controller system from the viewer platform. In some embodiments, the third data can be based on the second data. In some embodiments, the third data can also be based on an interaction of the viewer with the game participation feature(s) associated with the game. For example, if a viewer has purchased an item to add an obstacle to the game, this information can become part of the third data.

At step 1410, fourth data can be generated based on the third data at the controller system. In some embodiments, the fourth data can enable the player platform to alter the game based on the interaction of the viewer with the game participation feature(s) associated with the game. For example, if the third data includes information on a viewer purchasing an item to add an obstacle to the game, the fourth data can also include this information such that the player platform displays the obstacle to the player.

At step 1412, the fourth data can be transmitted from the controller system to the player platform.

According to some embodiments, the method 1400 can include a step, where fifth data can be generated based on the first data at the controller system. In some embodiments, the fifth data can enable a broadcaster platform to provide a broadcasting feature(s) associated with the game to a broadcaster. These broadcasting features can include features described above in reference to the interfaces shown in FIGS. 3, 8, 15, and 18.

According to some embodiments, the method 1400 can include a step, where the fifth data can be transmitted from the controller system to the broadcaster platform.

According to some embodiments, the method 1400 can include a step, where sixth data is received at the controller system from the broadcaster platform. In some embodiments, the sixth data can be based on the fifth data. In some embodiments, the sixth data can also be based on an interaction of the broadcaster with the broadcasting feature(s) associated with the game. For example, if the broadcaster has specified a new currency unit name using the currency interface as shown in FIG. 8 or 18, this information can be part of the sixth data.

According to some embodiments, the method 1400 can include a step, where payment information associated with the viewer at the viewer platform can be received at the controller system from a payment system.

While some of the systems and platforms described above have been discussed in singular terms, they do not need to be implemented using singular physical entities. For example, the viewer controller system 108 can be implemented using multiple heterogeneous systems, which can be located in different countries. As another example, the viewer platform 106 can comprise a computer (located in the same physical space as the player 103) and a cloud-based storage space (located in the same physical space as the viewer controller system 108 which may be located in a different country than where the player 103 is located).

While the above described features, components, or steps have been discussed in the context of video gaming, they are also applicable to other fields. The systems and methods described herein support any type of streaming data, which can be in any format, including video, sound, text, graphics, and any other binary data. Moreover, data, which is transmitted between systems, can include streaming data but is not restricted to streaming data. Where the term “streaming data” is used herein, disclosed systems and methods can still work even if the streaming data is replaced with non-streaming data and/or a combination of streaming and non-streaming data.

Various other modifications, including additions and removals, can be made to the exemplary embodiments discussed without departing from the scope of the present disclosure. For example, while the embodiments described above refer to particular features, components, or particular steps, the scope of this disclosure also includes embodiments having different combinations of features, components, or steps, and embodiments that do not include all of the above described features, components, or steps.

It is to be understood that the disclosed subject matter is not limited in its application to the details of construction and to the arrangements of the components set forth in the description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, systems, methods and media for carrying out the several purposes of the disclosed subject matter.

Although the disclosed subject matter has been described and illustrated in the foregoing exemplary embodiments, it is understood that the present disclosure has been made only by way of example, and that numerous changes in the implementation of the disclosed subject matter may be made without departing from the spirit and scope of the disclosed subject matter.

What is claimed is:

1. A method of controlling an online video game, comprising:
receiving, at a controller system from a player platform, first data associated with a game played at the player platform;
generating, at the controller system, second data based on the first data, wherein the second data enables a viewer platform to provide one or more game participation features associated with the game to a viewer;
transmitting, from the controller system to the viewer platform, the second data;
receiving, at the controller system from the viewer platform, third data based on the second data, wherein the third data is based on an interaction of the viewer with the one or more game participation features associated with the game;
generating, at the controller system, fourth data based on the third data, wherein the fourth data enables the player platform to alter the game based on the interaction of the viewer with the one or more game participation features associated with the game; and
transmitting, from the controller system to the player platform, the fourth data.

2. The method of claim 1, wherein the second data further enables the viewer platform to display the game in real time or substantially in real time.

3. The method of claim 1, wherein the first data is streaming data.

4. The method of claim 3, wherein the streaming data is received from a streaming data system that is connected to the player platform.

5. The method of claim 1, wherein the one or more game participation features includes at least one of: a game altering feature, chatting, voting, sponsoring, placing a bet, playing a sub-game, or purchasing an item.

6. The method of claim 5, wherein the game altering feature includes at least one of: changing a rule of the game, voting for a change to the game, or impacting a specific player of the game.

7. The method of claim 1, wherein the game played at the player platform is at least one of: a multiplayer online game, a simulation game, an adventure game, a strategy game, an action game, a first person shooter game, a sport game, a war game, a racing game, a role-playing game, or a puzzle game.

8. The method of claim 1, wherein a type of the game determines the one or more game participation features associated with the game.

9. The method of claim 1, further comprising:
generating, at the controller system, fifth data based on the first data, wherein the fifth data enables a broadcaster platform to provide one or more broadcasting features associated with the game to a broadcaster;
transmitting, from the controller system to the broadcaster platform, the fifth data; and
receiving, at the controller system from the broadcaster platform, sixth data based on the fifth data, wherein the sixth data is based on an interaction of the broadcaster with the one or more broadcasting features associated with the game.

10. The method of claim 1, further comprising:
receiving, at the controller system from a payment system, payment information associated with the viewer at the viewer platform.

11. A server for controlling an online video game, comprising:
a memory that stores a module; and
a processor configured to run the module stored in the memory that is configured to cause the processor to:
receive, from a player platform, first data associated with a game played at the player platform;
generate second data based on the first data, wherein the second data enables a viewer platform to provide one or more game participation features associated with the game to a viewer;
transmit, to the viewer platform, the second data;
receive, from the viewer platform, third data based on the second data, wherein the third data is based on an interaction of the viewer with the one or more game participation features associated with the game;
generate fourth data based on the third data, wherein the fourth data enables the player platform to alter the game based on the interaction of the viewer with the one or more game participation features associated with the game; and
transmit, to the player platform, the fourth data.

12. The server of claim 11, wherein the second data further enables the viewer platform to display the game in real time or substantially in real time.

13. The server of claim 11, wherein the first data is streaming data.

14. The server of claim 13, wherein the streaming data is received from a streaming data system that is connected to the player platform.

15. The server of claim 11, wherein the one or more game participation features includes at least one of: a game altering feature, chatting, voting, sponsoring, placing a bet, playing a sub-game, or purchasing an item.

16. The server of claim 15, wherein the game altering feature includes at least one of: changing a rule of the game, voting for a change to the game, or impacting a specific player of the game.

17. The server of claim 11, wherein the game played at the player platform is at least one of: a multiplayer online game, a simulation game, an adventure game, a strategy game, an action game, a first person shooter game, a sport game, a war game, a racing game, a role-playing game, or a puzzle game.

18. The server of claim 11, wherein a type of the game determines the one or more game participation features associated with the game.

19. The server of claim 11, wherein the module stored in the memory is further configured to cause the processor to:
generate fifth data based on the first data, wherein the fifth data enables a broadcaster platform to provide one or more broadcasting features associated with the game to a broadcaster;
transmit, to the broadcaster platform, the fifth data; and
receive, from the broadcaster platform, sixth data based on the fifth data, wherein the sixth data is based on an interaction of the broadcaster with the one or more broadcasting features associated with the game.

20. The server of claim 11, wherein the module stored in the memory is further configured to cause the processor to:
receive, from a payment system, payment information associated with the viewer at the viewer platform.

21. A non-transitory computer readable medium having executable instructions operable to cause a server for controlling an online video game to:
receive, from a player platform, first data associated with a game played at the player platform;
generate second data based on the first data, wherein the second data enables a viewer platform to provide one or more game participation features associated with the game to a viewer;
transmit, to the viewer platform, the second data;
receive, from the viewer platform, third data based on the second data, wherein the third data is based on an interaction of the viewer with the one or more game participation features associated with the game;
generate fourth data based on the third data, wherein the fourth data enables the player platform to alter the game based on the interaction of the viewer with the one or more game participation features associated with the game; and
transmit, to the player platform, the fourth data.
